(19) United States
(12) Patent Application Publication
(10) Pub. No.: US 2015/0341988 A1
(43) Pub. Date: Nov. 26, 2015

(54) RADIANT HEATER COMPRISING A HEATING TUBE ELEMENT

(71) Applicants: HELMUT HAIMERL, (US); LARS KEUSSEN, (US); QIXING WITTMANN-ZHANG, (US)

(72) Inventor: ROBERT MESSMER, FELDKIRCHEN-WESTERHAM (DE)

(21) Appl. No.: 14/655,337

(22) PCT Filed: Dec. 20, 2013
(86) PCT No.: PCT/EP2013/003925

§ 371 Date: Jun. 25, 2015

(30) Foreign Application Priority Data
Dec. 28, 2012 (DE) 10 2012 025 299.4

(51) Int. Cl. H05B 3/02; H05B 3/04; H05B 3/42; H05B 3/14

(52) U.S. Cl. CPC H05B 3/026; H05B 3/145; H05B 3/04; H05B 3/141; H05B 3/42

(57) ABSTRACT

A radiant heater includes at least one heating tube element comprising a heating tube which is transparent or semi-transparent to infrared radiation, and carbon fibers arranged within the heating tube. The carbon fibers form an infrared heating coil comprising a carbon string. The infrared heating coil is dimensionally stable. At least one infrared reflector comprises a focusing curvature which comprises a focus area. The at least one infrared reflector is adapted to the infrared spectrum of the at least one heating tube element. The at least one heating tube element is arranged in the focus area of the curvature A housing comprises a border side structure, a rear side structure, and at least one front face which is open, transparent or semi-transparent for infrared radiation. The border side structure and the rear side structure are arranged to surround the front face so as to shield from infrared radiation.

### CROSS REFERENCE TO PRIOR APPLICATIONS

This application is a U.S. National Phase application under 35 U.S.C. §371 of International Application No. PCT/EP2013/003925, filed on Dec. 20, 2013 and which claims benefit to German Patent Application No. 10 2012 025 299.4, filed on Dec. 28, 2012. The International Application was published in German on Jul. 3, 2014 as WO 2014/102013 A9 under PCT Article 21(2).

### FIELD

The present invention relates to a radiant heater with a heating tube element which comprises a heating tube, which is transparent or semi-transparent for infrared radiation. The heating tube is arranged in a focus area of at least one reflector having a focusing curvature. The at least one heating tube element is arranged in a housing having at least one front side which is open or transparent or semi-transparent for infrared radiation.

### BACKGROUND

Such a radiant heater has previously been described in DE 39 03 540 A1. The reflector here serves to align the heat radiation to an open front side of the housing.

The heating tubes used in the prior art radiant heaters are not described in detail in DE 39 03 540 A1 and can comprise as an infrared radiator a heating element made of carbon fibers, as is described in EP 1 168 418 B1. The heating element is made of carbon fibers and is arranged in a quartz tube, wherein the carbon fibers have the shape of a helix of a carbon tape. This helix of a carbon tape of carbon fibers has the disadvantage that it shadows the reflector in a broadband way so that the shadowed area of the reflector can not contribute to the reflection of the infrared radiation in the direction of the front face of the radiant heater, which is open or transparent or semi-transparent for the infrared radiation.

### SUMMARY

An aspect of the present invention is to provide an improved radiant heater that better uses the infrared radiation of carbon fibers.

In an embodiment, the present invention provides a radiant heater which includes at least one heating tube element comprising a heating tube which is transparent or semi-transparent to infrared radiation, and carbon fibers arranged within the heating tube. The carbon fibers are configured to form an infrared heating coil comprising a carbon string. The infrared heating coil is configured to be dimensionally stable. At least one infrared reflector comprises a focusing curvature which comprises a focus area. The at least one infrared reflector is adapted to the infrared spectrum of the at least one heating tube element. The at least one heating tube element is arranged in the focus area of the curvature A housing comprises a border side structure, a rear side structure, and at least one front face which is configured to be open, transparent or semi-transparent for infrared radiation. The border side structure and the rear side structure are arranged to surround the front face so as to shield from infrared radiation.

### BRIEF DESCRIPTION OF THE DRAWINGS

The present invention is described in greater detail below on the basis of embodiments and of the drawings in which:

FIG. 1 shows a diagram of an infrared wavelength spectrum;

FIG. 2 shows a schematic cross-section through an end area of an infrared heating tube element;

FIG. 3 shows with FIGS. 3A and 3B diagrams of reflection coefficients as a function of the infrared wavelength for three different qualities QI to QIII of anodized aluminum sheets;

FIG. 4 shows a schematic cross-section through an elongated infrared reflector;

FIG. 5 shows with FIGS. 5A, 5B and 5C schematic cross-sections through a radiant heater according to a first embodiment of the present invention;

FIG. 6 shows with FIGS. 6A, 6B and 6C schematic cross-sections through a radiant heater according to a second embodiment of the present invention;

FIG. 7 shows in FIG. 7A a schematic cross-section through the radiant heater according to FIG. 6 along a section line A-A, shown in FIG. 7B;

FIG. 8 shows with FIGS. 8A and 8B schematic views of a radiant heater in a wall mounting and a ceiling mounting;

FIG. 9 shows a schematic view of radial heaters on a height-adjustable post;

FIG. 10 shows a schematic view of a radiant heater in an umbrella shape;

FIG. 11 shows a schematic cross-section through the patio heater according to FIG. 10 in detail;

FIG. 12 shows with FIGS. 12A and 12B a radiant heater according FIG. 11 as a stand heater and a ceiling heater, and with the FIGS. 12C, 12D and 12E transparency curves for different glass qualities of a front glass plate;

FIG. 13 shows with FIGS. 13A and 13B a radiant heater with an enveloping structure in the form of a lampshade in the combination of stand heater/floor lamp and ceiling heater/ceiling lamp;

FIG. 14 shows with FIGS. 14A and 14B schematic cross-sections through an infrared heating tube element;

FIG. 15 shows with FIGS. 15A and 15B schematic cross-sections through an infrared heating tube element equipped with an infrared reflector;

FIG. 16 shows a schematic cross-section through a compact radiant heater according to an embodiment of the present invention;

FIG. 17 shows a principal sketch with remote-controlled performance adjustment and temperature control of a radiant heater by means of a portable controller;

FIG. 18 shows an interaction of a control and temperature control module integrated in a radiant heater with a freely positionalable temperature sensor unit and a portable control unit;

FIG. 19 shows a schematic cross-section through an embodiment of the radiant heater in form of a dark radiator;

FIG. 20 shows with FIGS. 20A and 20B schematic cross-sections through an infrared radiator according to an embodiment of the present invention;

FIG. 21 shows a schematic cross-section of an intermediate wall in the infrared radiator according to FIG. 20;

FIG. 22 shows with FIGS. 22A and 22B schematic views of a fan heater having an infrared heater in accordance with an embodiment of the present invention.

### DETAILED DESCRIPTION

An embodiment of the present invention comprises a radiant heater with a heating tube element. The heating tube element comprises a heating tube which is transparent or semi-transparent for infrared radiation. The heating tube is located in a focus area of reflector having at least a focusing curvature. The at least one heating tube element is arranged in a housing having at least one front side which is open or transparent or semi-transparent for infrared radiation. The housing comprises boundary- and rear sides which provide a shielding of infrared radiation. The at least one heating tube element comprises in the heating tube a plurality of carbon fibers forming a dimensionally stable infrared heating coil of a carbon string, wherein the reflector is an infrared reflector which is adapted to the infrared spectrum of the heating tube element.

Compared to a heater comprising a heating tube element having a carbon tape, the heater has the advantage of a reduced shadowing of the infrared reflector since the carbon fibers form a dimensionally stable infrared coil from a carbon string. A carbon string does not shadow the infrared reflector in a broadband way since the cross-section of the carbon string is round or circular, and thus a coil of the carbon string allows larger reflective spaces between the turns of the coil than a coil of a carbon tape shadowing the infrared reflector in a broadband way.

In an embodiment of the present invention, the carbon string of the infrared heating coil can, for example, comprise laid, interlaced, braided, knitted or woven carbon fibers, or any other manner of connections between the carbon fibers with each other. The braided connection of carbon fibers is particularly advantageous since it connects the carbon fibers together within a most narrow space so that the dimensional stability of an infrared heating coil of a braided carbon string is provided in a reliable and durable way.

It is further provided that the infrared heating coil has, in an operating state, an infrared radiation of an infrared wavelength having a maximum in a transition area between IR-A and IR-B. In this context, under a transition area, an infrared wavelength λ_{R} between 1.2 μm≦R≦2.4 μm is to be understood so that the borderline of 1.4 μm between the short-wave infrared range IR-A and the medium wave infrared range IR-B, which is characterized by the absorption line of the infrared spectrum of water molecules, is included in the transition area.

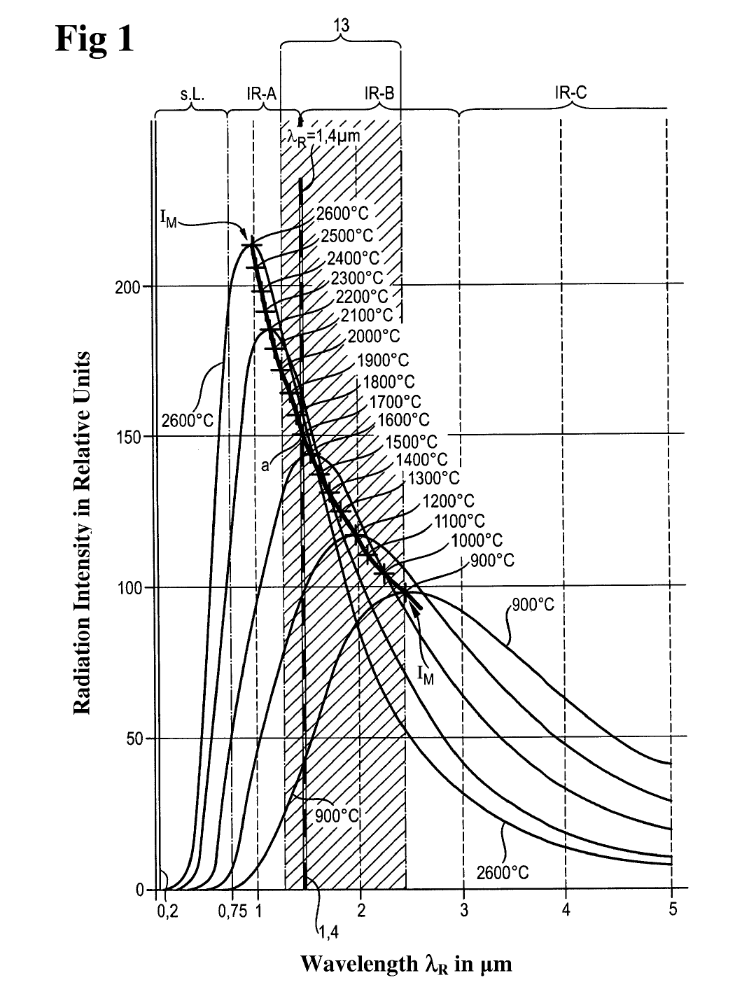

In an embodiment of the present invention, the location of the maximum of the infrared radiation of the infrared radiation coil in this transition is provided so that the carbon fibers of the infrared heating coil have an operating temperature T_{B} between 1400° C.≦T_{B}≦1800° C., for example, between 1500° C.≦T_{B}≦1750° C., for example, between 1580° C.≦T_{B}≦1620° C. This will be explained in detail with help of the diagram in the attached FIG. 1.

In order to let the carbon fibers of the dimensionally stable carbon string of infrared heating coil radiate in the mentioned temperature ranges, in an embodiment of the present invention, end portions of the infrared heating coils can, for example, be enclosed by metal transition elements, for example, of nickel. The metal transition elements merge into molybdenum tapes, which are in electrical connection with via contacts of gas-tight ends of the heating tube.

A corresponding supply voltage of typically 100 V to 230 V can therefore be applied through the via contacts to the infrared heating coil of carbon fibers which, compared with the tape-shaped carbon fibers (Flake), has the advantage that the upstream voltage regulation, as required for the radiation heating elements having tape-shaped carbon fibers (Flake) and power control as required by halogen heaters, can be omitted.

Because of the negative temperature coefficient of the heating resistor of the carbon fiber the operating temperature is achieved in a few seconds, for example, between 1 to 3 seconds, the above-mentioned transition area according to the present invention of the infrared radiation also extends partially into the broader area of rapid infrared medium waves of the IR-B spectrum, as it is also illustrated by FIG. 1.

In an embodiment of the present invention, the heating tube can, for example, have a quartz glass which is transparent for infrared radiation in the transition area from IR-A to IR-B having a transparency coefficient of at least TR≧0.99. This also means that the sum of reflection coefficient and absorption coefficient of the transparent quartz glass is ≦0.01 in the infrared radiation transition area of IR-A to IR-B.

In an embodiment of the present invention, the heating tube can, for example, have a quartz glass which is semi-transparent for infrared radiation in the transition area from IR-A to IR-B having a frosted or having particle blasted opaque outer surface. The visible part of the infrared heating coil will in this case appear diffuse so that the visual light portion of infrared heating coil is reduced outside of the heating tube and a glare to the eyes, as usual with halogen heaters, is prevented. The absorption coefficient of the quartz tube is here slightly higher so that the transmission coefficient may drop to 0.90.

In an embodiment of the present invention, a reflecting and curved surface of the infrared reflector can, for example, comprise minor coatings, facing towards the infrared coil, of metal oxides, for example, Al₂O₃, having a reflection coefficient between 0.85≦R≦0.98, for example, between 0.92≦R≦0.98 for infrared radiation of the wavelength λ_{R} between 1.2 μm≦λ_{R}≦2.4 μm in the transition area from IR-A to IR-B up to IR-C.

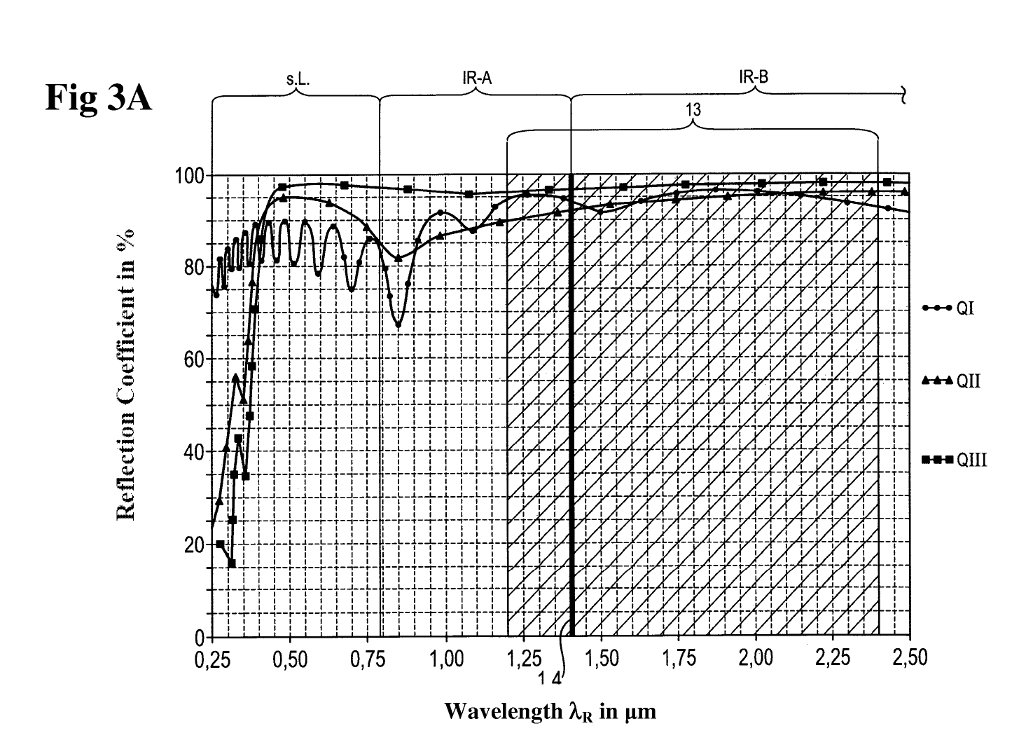

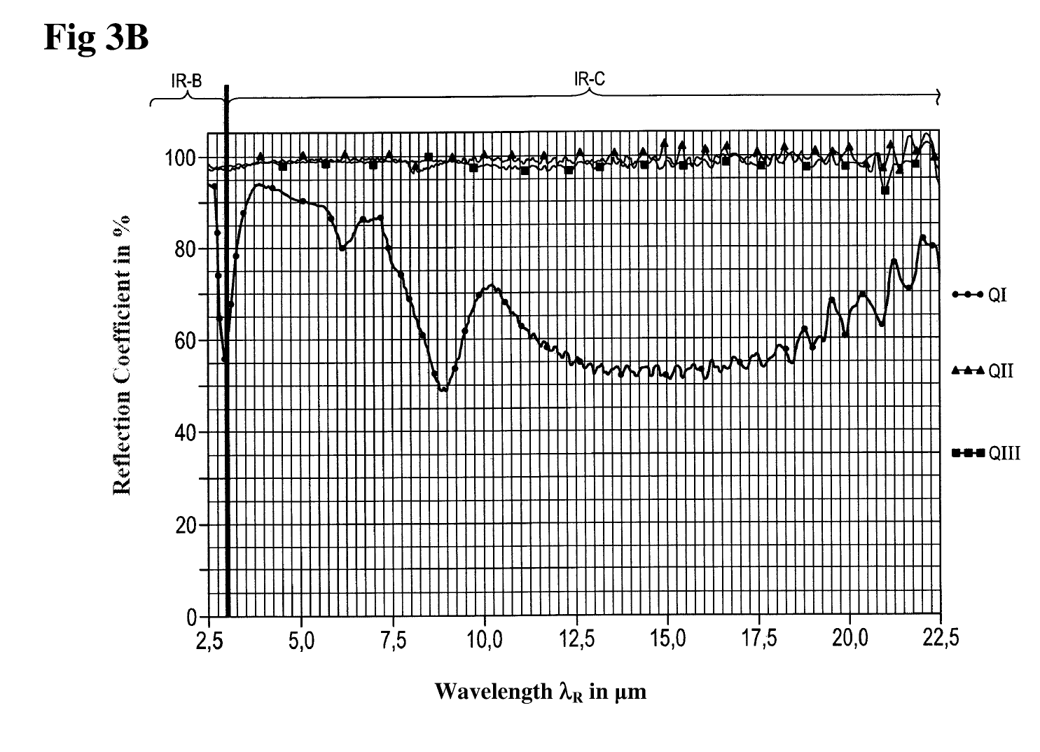

The advantage of such metal oxide reflecting coatings is that the reflection coefficient R decreases before the preferred infrared wavelength range, but comprises in the overall infrared transition area of interest up to the long-wave range, which is used according to the present invention, a high reflection coefficient R adapted to the transition area, as shown by the enclosed diagram of FIG. 3.

In an embodiment of the present invention, the curvature of the infrared reflector comprises embossed segment strips in boundary areas of the cross section which are pressed step by step into a sheet of aluminum alloy having an infrared reflective coating. This has the advantage that embossed longitudinal crimps between the segment strips are thereby formed which provide an increased dimensional stability over the entire length of the infrared reflector. The segment strips support the orientation of the reflection, and an orientation of the boundary areas is in a direction of on the open or infrared-transparent or infrared semi-transparent front side of the housing of the radiant heater is intensified.

In an embodiment of the present invention, the infrared reflector is arranged directly on the heating tube and comprises layers of oxide ceramics. On the heating tube made of quartz glass, an oxide ceramic layer, for example, MgO, SiO₂, Al₂O₃, is arranged, with lies in its reflection coefficient R in the above mentioned range for the infrared wavelength transition area between the IR-A to IR-B and is up to IR C.

Such a heating tube can, for example, have an infrared reflector on the heating tube itself can, in an embodiment of the present invention, be surrounded by a protective tube which is transparent or semi-transparent to infrared radiation. Such a protective tube has a minimum temperature resistance of 1200° C. so that, during an implosion or breakage of the quartz heating tube, the environment, and in particular the construction of the heater housing, is protected.

In an embodiment of the present invention, an air convection channel can, for example, be arranged between the protective tube and the housing partly surrounding the protective tube with boundary and rear sides. This air convection channel advantageously allows the housing surrounding the heater, and partially the protective tube, to be is cooled and a delivery of the absorbed energy of the air and moisture molecules of the environment of the radiant heater to be heated.

In an embodiment of the present invention which comprises an infrared reflector spaced apart from the heating tube, an air convection channel can, for example, be arranged between the infrared reflector and a surrounding housing, having openings to the surrounding air, which have different heights above sea level in mounting arrangements of the radiant heater, through which a cooling air convection is formed along a curved outer surface of the infrared reflector and an inner surface of the housing spaced from the outer surface.

Elongated slots are therefore provided between the boundary sides of the housing and the boundary areas of the infrared reflector, wherein the infrared reflector itself is held floatingly by resilient rubber-elastic silicon profile pieces in boundary sides of the housing. Between two semi-shells of the housing, a perforated metal strip is additionally held along the housing semi-shells over which an air convection can occur between the longitudinal columns of elongated slits and the perforated metal strip between the two housing shells. The housing semi-shells may comprise accurately fitted production lengths of cast extruded aluminum profiles.

In an embodiment of the present invention, the inner surface of the housing can, for example, comprise rib-shaped protrusions which, for triggering of air vortices, protrude into the air convection channel. This has the advantage that the cooling exchange of heat between the reflector rear side and the inside of the housing surrounding the infrared reflector will be intensified.

In an embodiment of the present invention, the housing can, for example, comprise two extruded aluminum semi-shells having a structured inner surface, wherein the semi-shells are connected by at least two connecting members of an extruded connecting profile to a housing rear side in a form-fit way. It is therefore provided that, starting at least from the end faces of the extruded housing, semi-shells connection profile pieces can be inserted in corresponding receiving pockets on the inside of the aluminum semi-shells. During assembly of end side covers, the end side covers can be fixed to fixing elements of the housing semi-shells.

As set forth above, the perforated metal strip is arranged at the housing rear side between the two extruded aluminum semi-shells and the connecting pieces. The transitions of the aluminum semi-shells therefore comprise corresponding elongated guide grooves, in which the perforated metal strip can be inserted.

In an embodiment of the present invention, the at least one front side of the housing, open or transparent or semi-transparent for infrared radiation, can, for example, comprise a front cover which is covered by a front glass plate, which is highly temperature-resistant and which appears white or colored or opaque black in the visible light spectrum. This front glass panel, which appears white or colored or opaque dark brown or black in the visible light spectrum, is in the infrared transition area between the IR-A and the IR-B highly transparent with a transparency coefficient of ≧0.9 although it converts the energy of the visible spectrum by absorption and reflection very strongly in the white embodiment, and somewhat less strongly in the colored appearing front glass panel embodiment, mainly into thermal energy.

The at least one front of the housing, transparent or semi-transparent for infrared radiation, can here comprise an air convection channel between the front glass plate, appearing white or colored or opaque in the visible light spectrum, and an inner wall of the infrared reflector, facing the heating tube element. For this purpose, the air convection channel comprises an air inlet opening and an air outlet opening in the form of longitudinal slots between the front glass plate and the inner wall of the infrared reflector. This air convection channel serves to cool the front glass plate, appearing white or colored or opaque black, which is merely suitable in operation temperatures of up to 800° C. in a long-term use.

It is alternatively also possible to provide a visual- and access-protective grille, to provide a vision or glare or weather conditions or access protection at the per se open side front of a radiant heater. The grille can, for example, comprise a stainless chromium/nickel-iron alloy or an anodized aluminum alloy sheet with high dimensional stability and high weather resistance.

In an embodiment of the present invention, the front side of the radiant heater can, for example, be covered by an infrared-absorbing front cover, wherein the material of the front cover absorbs the infrared radiation of the mid-wave IR-wavelength of the carbon heating coil and converts it into a long-wave IR-C radiation. The IR-C radiation is called as far-infrared radiation or long wave infrared radiation. The front cover forms in interaction with, for example, several infrared heating elements, a quick dark radiator, which can be used in domestic, commercial and industry, both inside and outside in a well-protected way, and which is suitable for a planar secure mounting in usual ceiling constructions.

For this purpose, a quartz tube can be used as infrared heating element having a carbon heating coil which is partially covered by an oxide ceramic reflector, wherein, in addition within the housing of the radiant heater, a heat shield made of a reflector material is arranged between the boundary sides and the rear side of the housing, the heat shield comprising a curvature with a focusing area made of an infrared reflecting aluminum oxide material, with an air convection channel, and which provides secure and low operating temperatures.

At the inner side of the structured front cover, a structure having protrusions is arranged to enable efficient heat absorption of the infrared spectrum of the infrared radiation of the carbon heating coil. On the outer side of the structured front cover, longitudinal ribs are arranged that form an aluminum heating profile having efficient heat dissipation to the ambient air for the IR-C radiation range. Such a dark radiant heater can be equipped with a three-stage control circuit for rough adjustment of heat power to be dispensed, and in addition comprise a sensitive temperature control for the indoor or outdoor heating.

For this purpose, an embodiment of the present invention provides that the radiant heater can, for example, comprise a receiving- and control module on circuit boards or on printed circuit boards in the housing of the radiant heater which is in a wireless operative connection to a portable control unit.

For this purpose, the portable controller may comprise at least one output power step switch and a continuous temperature controller and a temperature sensor. The temperature sensor thereby detects a temperature value of the environment to which the heater is directed. The temperature controller is thereby adapted to regulate the ambient temperature according to a temperature setpoint which is adjustable at the control device.

It is furthermore provided that the heating radiator comprises, on its rear side, guide rails in which fastening elements are arranged.

For this purpose, the fastening elements can slide displaceably in the guide rails for a settable fixation of a holding arm, wherein the holding arm is intended for a fixation of the radiant heater at a wall, ceiling or tripod, with a focus on an environment to be warmed or to be heated.

It is furthermore provided to arrange a patio heater on a post and equip at least one ring-shaped heating tube element with a ring-shaped infrared reflector of a radiant heater. In an embodiment of the present, invention the patio heater can, for example, have two ring-shaped carbon fiber heating elements with a very short response time of 2 to 3 seconds and a high radiation efficiency>93% for the heating of the air humidity and the surfaces with low penetration depth with a very long service life>10000 hours of the carbon heating coil and the quartz tube with a frosted surface to produce a pleasant, diffuse visible light. The post can thereby be adjusted in height and protrude into a central receptacle of the patio heater.

The base of the stand may be formed so that a height-adjustable telescopic rod protrudes into a central receptacle of the post base foot.

In an embodiment of the present invention, an enveloping structure providing at the same time colored light and infrared heat radiation in an environment is provided, wherein the enveloping structure comprise a radiant heater of the previously described type. Such enveloping structures, that are transparent both for colored light as well as infrared radiation, can have different, umbrella like, column like or spherical contours, provide, particularly caused by the carbon heating coil of infrared heating tube in the area of the transition between IR-A to IR-B, a warm, visible light color in outdoor areas of terraces or indoor areas of domestic rooms.

It is moreover contemplated that a infrared radiator comprises a radiant heater of the kind described above. For this purpose, the infrared radiator can be arranged in a housing, wherein the air to be heated flows in at least three air convection channels through the infrared radiator housing convectively and heats moisture- and air-molecules as well as intermediate walls and interior walls of the infrared radiator casing. An air convection channel positioned in close proximity to the infrared heating tubes is here particularly effective because the infrared radiation range includes the water absorption line in the transition area between IR-A and IR-B, which forms the start of the IR-B range, and consequently moisture molecules can be heated quickly and intensively in this air convection area and air flowing out of the corresponding openings of the infrared radiator is heated in a few seconds.

To transfer the radiant energy within the infrared radiator from the transition area between IR-A to IR-B into an air heating IR-C of the far infrared spectrum, the infrared radiator comprises intermediate walls having a highly effective radiation absorption, which provides, after conversion of the radiation, that an outer contour of the infrared radiator can also emit heat to the room air at a permissible surface temperature.

In an embodiment of the present invention, it is further provided that a fan heater can, for example, be equipped with a radiant heater. For this purpose, the heater fan comprises at least one ring-shaped or U-shaped heating tube element having a ring- or U-shaped adapted carbon heating coil. A fan is oriented onto the radiant heater having ring-shaped or U-shaped heating tube element so that the air- and moisture molecules are heated from the infrared radiation from the at least one ring-shaped or U-shaped heating tube element in the inventive transition area from IR-A to IR B.

The advantage of fast absorption of infrared radiation in the range of 1.4 μm of the infrared spectrum is here also used according to the present invention, wherein the moisture molecules of the ambient air may be heated in a few seconds by the carbon heating coil at the temperatures indicated above, and are mixed in the air flow of the fan with the air molecules to a warming up to a heating air flow depending on the speed setting or speed control of the fan. In such a heating fan, heating tube elements having carbon coil in quartz tubes are, for example, used, wherein the quartz tubes are partially coated with an oxide ceramics reflector. The thermal energy is absorbed from the efficient IR-radiation of the hot heating tube elements by flowing air outside of the heater.

The present invention will now be explained in greater detail with reference to the drawings.

FIG. 1 shows a diagram of an infrared wavelength spectrum with wavelengths λ_{R} on the abscissa and the radiation intensities in relative units on the ordinate. The infrared wavelength range between 0.78 μm≦λ_{R}≦5 μm is usually divided in a near-infrared range, including the wavelengths between 0.78 μm≦λ_{R}≦3 μm, and a far or long-wave infrared range with wavelengths of λ_{R}≧3 μm. The near infrared range between 0.78 μm≦λ_{R}≦3 μm is further divided into a short-wave infrared range IR-A and a medium wave infrared range IR-B. The borderline is the absorption line for water or moisture in the air at 1.4 μm, so that the IR-A range is between is between 0.78 μm≦λ_{R}≦1.4 μm and the IR-B range is 1.4 μm≦λ_{R}≦3 μm.

Halogen heaters are usually in operated at 2400-2600° C., wherein the maximum intensity is in the short-wave infrared range at a wavelength λ_{R} of about 1.0 μm.

The intensity maximum I_{M} for different annealing temperatures of a filament shifts from the short-wave IR-A range though the medium-wave IR-B range up to the long-wave IR-C, wherein the maximum radiation intensity decreases with increasing infrared wavelength, as the curve a shows for the maximum wavelength at operating temperatures from 2600° C. for halogen radiant heater up to operating temperatures of 900° C. for resistor radiant heaters. There between are the maximum values of heating tube elements of the present invention, in which carbon fibers are used which are braided to a carbon string and are operated at filament operating temperatures T_{B} between 1400° C.≦T_{B}≦1800° C.

The maximum values of the radiation intensity in relative units occur in these filament operating temperatures at infrared wavelengths of >1.2 μm, so that it is advantageous if an infrared wavelength range between 1.2 μm≦λ_{R}≦2.4 μm is selected for the inventive infrared heater having carbon fibers and all components, e.g., the infrared heating coil or infrared reflector of the radiant heater, are optimized for this infrared range according to the present invention.

This inventive and optimized infrared range forms a transition area 13 of the IR-A to the IR-B infrared radiation range, so that both the maxima for the filament temperatures of 1400° C. to 1800° C. are in an advantageous manner in this inventive infrared transition area 13 of the present invention as well as the water absorption wavelength 1.4 μm is included in this infrared transition area 13. That means namely, that humid air, which prevails both in outdoor and indoor areas, absorbs particularly quick the radiant energy and generates a pleasant heated air atmosphere at the usual humidity in Central Europe using such heaters.

This advantageous effect is not achieved if the infrared heater is exclusively operating or is optimized in the medium wave IR-B range or the long-wave IR-C range, under exclusion of the water absorption wavelength 1.4 μm. An optimization in the inventive infrared transition area is essentially determined by corresponding adjusted reflective properties of the infrared reflectors, which are used in such heaters.

FIG. 1 shows, however, that carbon strings or carbon heating coils operated in a temperature range between 1400° C. and 1800° C., can best achieve an energy balance in the inventive infrared transition area with the infrared wavelengths between 1.2 μm≦λ_{R}≦2.4 μm. For this purpose, however, the problem must be solved to provide a dimensionally stable carbon string from a variety of carbon fibers that can be brought at annealing temperatures between 1400° C. and 1800° C. in a quartz tube free from the inner wall of the quartz tube in a dimensionally stable way. The problem must also be solved that the ends of the carbon heating coil must be passed through the heating tube, which usually consists of a quartz tube.

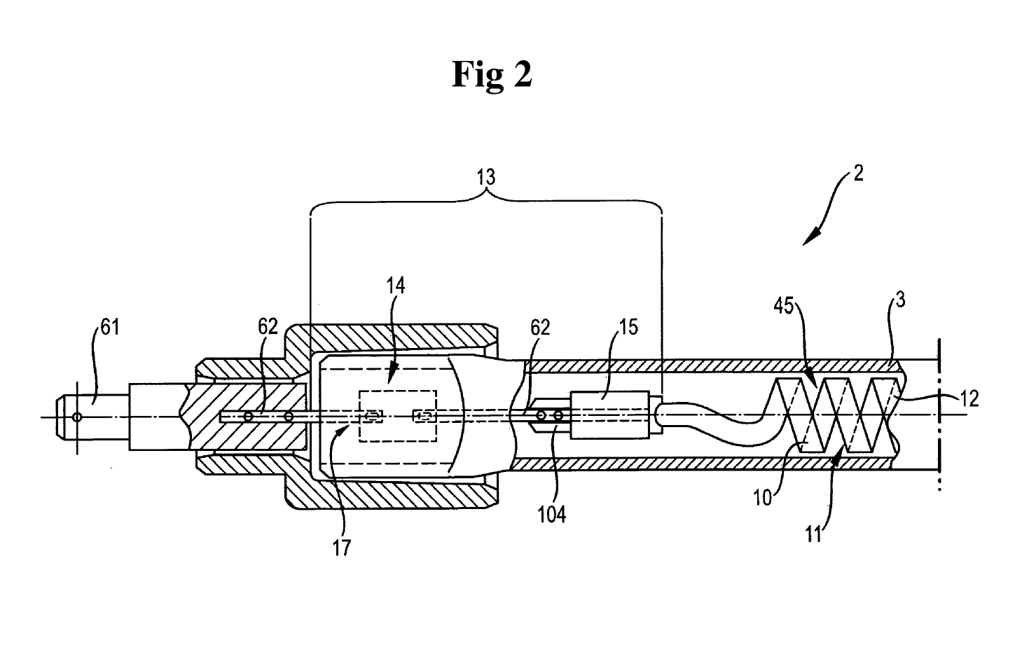

The solution to this problem is shown in FIG. 2 which shows a schematic cross-section through an end area 14 of an infrared heating tube element 2. The carbon string 12, formed as an infrared heating coil and, in this embodiment, braided and dimensionally stable, is at its end pressed into a metal transition element 15 of pure nickel, as here shown at one end of the carbon heating coil, wherein the metal transition element 15 made of nickel comprises an extension 104.

On the extension 104 a connecting wire 62 made of molybdenum is fixed, which is connected to a molybdenum band 16, on which the end area 14 of the quartz tube is pressed, whereby a via contact 17, which in turn consists of a molybdenum connecting string 62, protrudes from the compressed quartz tube end and merges into an external connector 61. Via the external connector 61, a heating current can now be applied from the outside on the carbon heating coil 45 through the via contacts 17, the molybdenum band 16, the molybdenum connecting string 62, and the metal transition element 15 of pure nickel. Since the resistance of a carbon fiber decreases with increasing temperature, the filament operating temperature T_{B} between 1400° C.≦TB≦1800° C. is achieved in a few seconds, without requiring a regulation of the starting current having a respective current limiting for the inventive heating tube element of the radiant heater.

Through the coil shaped structure of the dimensionally stable carbon heating coil 45 of braided carbon fibers 10, spacious gaps arise between the individual turns of the carbon heating coil 45 so that a shadowing of infrared reflector arranged on the heater tube or an infrared reflector mounted behind the heating tube is correspondingly low. An infrared reflector is required to align the infrared radiation from a rear side of the heating tube element 2, for example, to a front side of the radiant heater.

FIG. 3 shows with FIGS. 3A and 3B diagrams of reflection coefficients R as a function of the infrared wavelength λ_{R} representing three different qualities QI, QII and QIII of anodized aluminum sheets as reflectors. FIG. 3A shows a diagram for the wavelength range between 0.25 μm≦λ_{R}≦2.5 μm and the range of the visible light v.l., the range of short-wave infrared radiation IR-A between 0.78 μm≦λ_{R}≦1.4 μm with the absorption line of water at 1.4 μm as characteristic borderline to the medium-wave range IR—between 1.4 μm≦λ_{R}≦3.0 μm.

The inventive transition area 13 is shown hatched in FIG. 3A, and all three qualities QI, QII and QIII have excellent reflective properties with a reflection coefficient throughout the inventive transition area 13 between 1.2 μm≦λ_{R}≦2.4 μm of over 90% and for the quality QIII even up to 98% in the radiation range, which is important for the carbon heating coils used in the present invention.

FIG. 3A also shows the water absorption line of 1.4 μm as a plotted line, wherein the infrared reflector of quality QIII of an anodized aluminum sheet achieves for the first time a maximum value of R greater than 95%, which is even exceeded at 2.3 μm is held at 2 4 μm and which is held up to ≧10 μm at R=98%. FIG. 3A clearly shows that the inventive radiant heater achieves an energy-saving efficiency by the optimal adjustment of the filament temperature and the reflector wavelength range.

In the visible range v.l. of the light between 0.25 μm≦λ_{R}≦0 78 μm, the reflection coefficient for the QII and QIII qualities, which are excellent in the IR ranges of interest, decrease significantly. The reflection coefficient R then increases steeply and reaches for the inventive infrared wavelength range between 1.2 μm≦λ_{R}≦2.4 μm and up to 10 μm maximum values, which serve a 98% reflection in the inventive infrared transition area 13 and also above up to 10 μm, as shown in the following FIG. 3B.

The high IR-reflection thus remains in the long-wave infrared range>10 μm and also reflects a small percentage of the IR-C radiation of the carbon heating element with predominant absorption in the air.

The coordination between a high reflection factor in the essential frequency range with the filament temperature of heating tube element is important for energy efficiency because a high loss of radiation energy may otherwise occur, especially since such an infrared heating element at first radiates in all directions with the same radiant intensity and, without an infrared reflector, only a portion is emitted in the direction of a front side of a radiant heater.

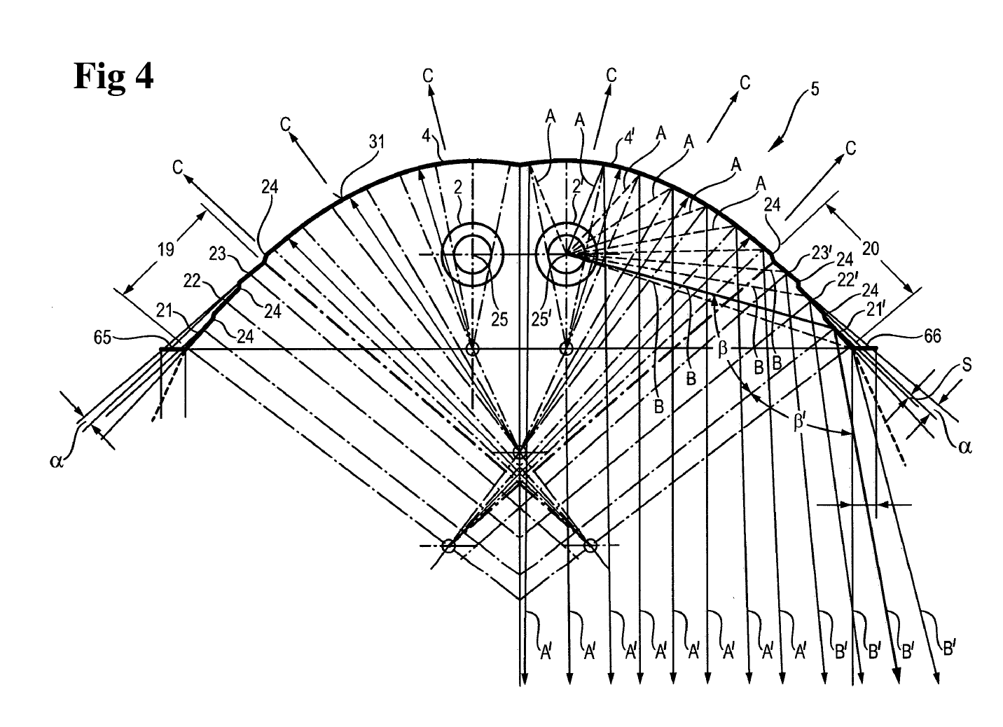

FIG. 4 shows a schematic cross-section through an elongated infrared reflector 5, comprising two focus regions 25 and 25′, in which two heating tube elements 2 and 2′ can be arranged in the focus regions 25 and 25′ of the curvatures 4 and 4′. The infrared radiation that hit the curvature of the infrared reflector 5 in direction of arrow A, are reflected as nearly parallel heating radiation in direction A′ on to a front side of a radiant heater.

To optimally benefit from such an elongated infrared reflector 5, in this embodiment, reflecting segment strips 21, 22 and 23 are arranged in a boundary area 19 and segment strips 21′, 22′ and 23′ are present in an opposite boundary area 20. These reflecting segment strips 21, 22 and 23 respectively 21′, 22′ and 23′ are formed planar over the entire length of the infrared reflector. At the transitions from one segment strips, for example 21, to the second segment strips, for example 22, the reflection angle changes stepwise, for example by 5°. At the same time a crimp 24, for example, 1 mm wide, is arranged in the transition.

The crimps 24 between the respective segment strips 21, 22 and 23 or 21′, 22′ and 23′ now additionally support the dimensional stability of the infrared reflector. Infrared radiation which is emitted by the infrared heating tube 2′ in the direction B to the strip segment 21′, are reflected in the direction B′, wherein the entrance angle β is equal to the exit angle β′. At the end of the boundary areas 19 and 20, the infrared reflector 5 comprise chamfers 65 and 66 that can be used to fix the infrared reflector 5 in its position within a housing of a radiant heater.

At the same time, infrared energy is not merely emitted in the main direction, but also at the rear side 31 of the infrared reflector 5, a residual heat occurs as radiation, because, in the infrared transition area, despite the adjusted suitable reflective properties, about 2% of the radiation is not reflected, but is either absorbed in the reflector material or, as indicated by the arrows the arrow direction C, are irradiated from the rear side 31 of the infrared reflector 5 up to 2%. Since the infrared reflector also absorbs a minimal amount of heat radiation, the infrared reflector during operation, in particular at filament temperatures of 1800° C., is heated up to 180° C., which results in a surrounding housing also being warmed.

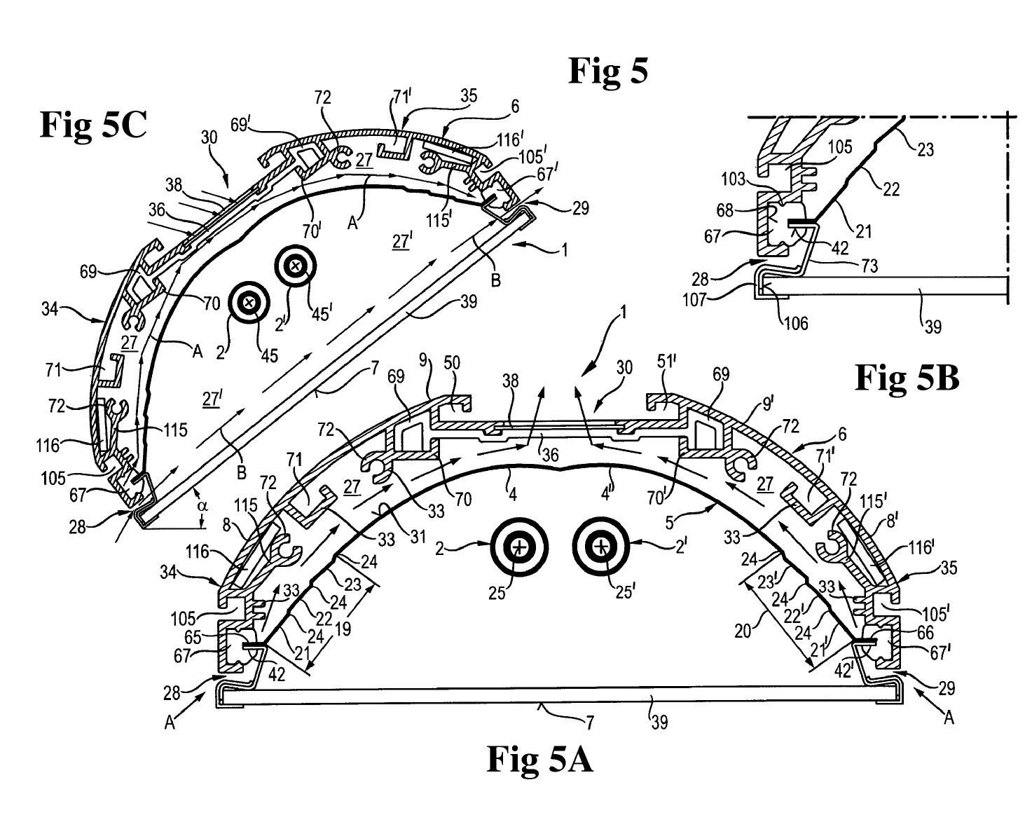

To reduce heating of the housing and the reflector, FIG. 5 shows with FIGS. 5A, 5B and 5C, schematic cross-sections through a radiant heater 1 according to a first embodiment of the present invention. As shown in FIG. 5A the radiant heater 1 has three main components, namely the first main component are two infrared heating tube elements 2 and 2′, as the second main component an infrared reflector 5 with two focus regions 25 and 25′ forming curvatures 4 and 4′, as well as a third main component, a housing 6 with border side structure 8 and 8′ and rear side structures 9 and 9′ and a front side 7, which may be covered by the infrared-transparent front glass plate 39 or may comprise a protection grille having protection grille lamellas.

As FIG. 5B illustrates in detail, the front glass plate 39 has on its edges 106 a circumferential U-shaped ornamental and clamping frame 107. The ornamental and clamping frame 107 does not merely surround the edges 106 of the front glass plate 39 but also connects the front glass plate 39 with S-shaped brackets 73 which protrude with one end in longitudinal slits 42 of silicone profile pieces 67. A second end of the bracket 73 is surrounded by the ornamental and clamping frame 107 and is clamped at the edges 106 of the front glass plate 39. The silicone profile pieces 67 are arranged in a form-fit way in a guide groove 68 in that the contour of the silicone profile pieces 67 are adapted to curvatures of a contour of the guide groove 68 or at a trapezoid shape of the cross-section of the guide groove 68.

In the longitudinal slots 42 and 42′ of the silicone profile pieces 67, chamfers 65 and 66 of the infrared reflector 5, already shown in FIG. 4, are arranged, so that the infrared reflector 5 and the front glass plate 39 are floatingly supported in the guide grooves 68 of the border side structures 8 and 8′. Due to this floating support, differences in thermal expansion coefficient between the housing 6 and the infrared reflector 5, and between the infrared reflector 5 and the front glass plate 39 are compensated and disturbing noises during heating and cooling of the heating tube elements 2 and 2′ of the radiant heater 1 are prevented.

The heating tube elements 2 and 2′ comprise the infrared heating coils 11 from a carbon string 12 shown in FIG. 2. To align the entire heat radiation of the infrared heating coils 11 of the heating tube elements 2 and 2′ in the direction to the front side 7 of the housing 6 as much as possible, the heating tube elements 2 and 2′ are arranged in the above-mentioned focus regions 25 and 25′ of the curvatures 4 and 4′ of the infrared reflector 5. The effect of the segment strips 21, 21′, 22, 22′, 23 and 23′ in the boundary area 19 and 20 has already been addressed in the description of FIG. 4.

The housing 6 of the front side 7 with the front glass plate 39 and the border side structures 8 and 8′ and the rear side structures 9 and 9′ surrounds the infrared reflector 5 and both heating tube elements 2 and 2′. An air convection channel 27 is thereby formed which extends from the rear side 31 of the infrared reflector 5 to a highly structured inner side of the border side structures 8 and 8′ as well as the rear side structures 9 and 9′. Bulges 33 of different characteristics protrude into the air convection channel 27, which cause air vortices in the air convection channel 27, thus intensifying the cooling of both the rear side 31 of the infrared reflector 5 as well as the rear side structure 9 of the housing 6.

The infrared reflector 5 is not rigidly fixed in the housing 6, but the chamfers 65 and 66 in the boundary areas 19 and 20 of the infrared reflector 5′ are held floatingly by the rubber-elastic silicone profile pieces 67 and 67 in the guide grooves 68, wherein the silicone rubber profile pieces 67 and 67′ are arranged merely piecewise or pointwise on the length of the guide grooves 68. Between the silicone profile pieces 67 and 67′ split or slot-shaped openings 28 and 29 are provided, through which an air exchange between the air convection channel 27 and the environment occurs in the direction of arrow A.

The housing 6 also has a central opening 30 in an upper region, via which, at a suitable position of the radiant heater 1, the heated air of the air convection channel 27 can exhaust, shown in FIG. 5A. The central openings 30 between two semi-shells 34 and 35 are therefore provided with a perforated metal strip 38, through which the heated air can exhaust or, at a modified location of the radiant heater 1, as shown in FIG. 5C, may flow into the air convection channel 27. Merely the difference in geodetic height between the openings 28, 29 and 30 is important for whether air flows into or off the air convection channel 27 through one of the openings 28, 29 or 30.

Since the openings 28 and 29 positioned in FIG. 5A at the same geodetic height, and the central opening 30 and the perforated plate 38 each have a higher geodetic height, ambient air flows through the openings 28 and 29 into the air convection channel 27 and out of the central opening 30 through the perforated plate 38.

In FIG. 5C, the front glass plate 39 of the radiant heater 1 is arranged relatively to the horizontal position at an inclination angle α, e.g., at a wall, so that the opening 28 has the lowest geodetic height and the air flowing through the opening 28 splits in two air convention channels 27 and 27′ in the direction of arrow A or arrow B. Ambient air also flows through the central opening 30 in the air convection channel 27. The air convection channel 27′ is formed between the front glass plate 39 and the infrared reflector 5 and reduces the thermal load of the front glass plate 39, which is designed for temperatures≦1200° C., whereas the carbon heating coils 45 and 45′ in the heating tube element 2 and 2′, adjacently arranged to the to the front glass plate 39, are designed for annealing temperatures up to 1800° C.

The two housing semi-shells 34 and 35 can, for example, be made of extruded aluminum profiles and can be held together in a form-fitting way by an end face cover on the one hand (not shown), and at least two connecting members 36 on the other hand, as shown in FIGS. 5A, 5C. These connecting members 36 are at least arranged at both end portions of the elongated housing 6. These connecting members 36 have bulges 69 and 69′, which engage with guide rails 70 or 70′ of the structured inner walls of the housing semi-shells 34 and 35.

A stable, form-fit connection between the two housing semi-shells 34 and 35 is thus provided wherein, at the inner walls of the housing semi-shells 34 and 35, not merely bulges to the formation of vortices are present, but additional bulges are incorporated to create guiding channels 71 and 71′ for cable connections on the one hand, and to create a plurality of attachment regions 72 for screw joints for attaching the end face cover (not shown) of the radiant heater on the other hand. Behind shielding ribs 115 and 115′, boards 116 and 116′ each with printed circuits of a control module for controlling power levels and for continuously regulation of ambient temperatures over radio connections to external temperature sensors are arranged.

The border side structures 8 and 8′ in FIGS. 5A, 5B and 5C comprise external assembly nuts 105 and 105′, which are provided for inserting, for example, in a suspended ceiling structure or for joining a plurality of radiant heaters 1 to radiant heater surface. The external assembly nuts 105 and 105′ therefore extend over the entire length of the radiant heater 1.

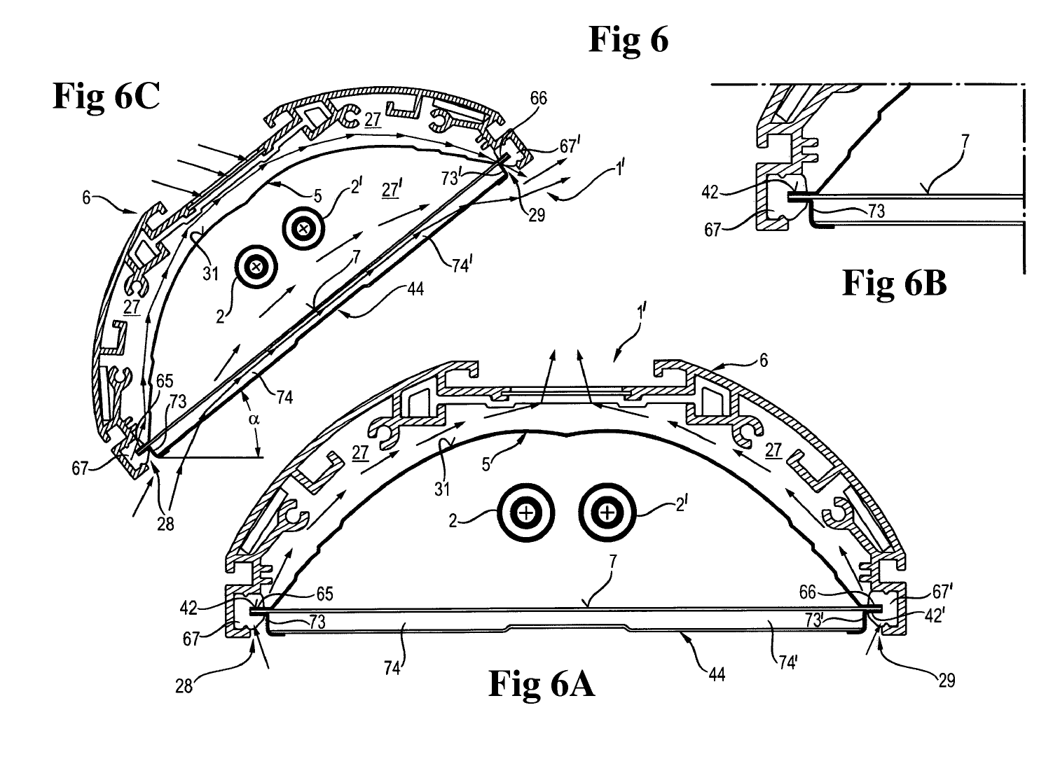

FIG. 6 shows with FIGS. 6A, 6B and 6C schematic cross-sections through a radiant heater 1′ according to a second embodiment of the present invention. Components having the same functions as in the previous drawings are identified with identical reference numerals and are not discussed separately.

The second embodiment of the radiant heater 1′ differs from the first embodiment in that, instead of a transparent front glass plate, a front grille structure 44 is now held at the front side 7 by means of brackets 73 and 73′. The front grille structure 44 comprises a formed and punched complete front shield made of stainless steel or an aluminum alloy and has shielding lamellas 74 and 74′ as a secure shielding of the heating tube elements against grasping.

Since the front grille structure 44 may reach a surface temperature up to 500° C. and can have thermal expansion differences compared to the housing 6, the brackets 73 and 73′ of the front grill structure are also supported together with the chamfers 65 and 66 of the infrared reflector 5 in the longitudinal slots 42 and 42′ of the silicon profile pieces 67 and 67′ floatingly against the housing.

The front grille structure 44 is designed so that approximately 75% of the front side 7 of the housing 6 is open and unobstructed to direct the infrared radiation of the heating tube element 2 and 2′ with the reflected portion of the infrared reflector 5 to the environment to be heated. The silicone profile pieces 67 and 67′, which each provide the floating mounting of infrared reflector 5 and the front grille structure 44, leave a sufficient area of the elongated opening 28 and 29 free so that, in the air convection channel 27, in any mounting orientation of the radiant heater 1′, an air convention can form which cools the rear side 31 of the infrared reflector.

Although the material of the infrared reflector 5, which consists of an anodized aluminum alloy, has a low absorption coefficient, the infra-red reflector can nevertheless be heated up to 180° C. and, due to the cooling air convection in the air convection channel 27 the rear side of the housing 6, reaches at most a temperature between 60° C. and 100° C., at a heating power of the heating tube elements of up to 3.2 kW. For the formation of the air convection channels, the same conditions apply which have already been discussed with reference to FIG. 5A. The same applies to the formation of the air convention channels 27 and 27′ of FIG. 6C, however, in FIG. 6C, air can get into the air convection channel 27′ through all openings of the front grille structure 44, if in contrary to FIG. 5C, no front glass plate is provided.

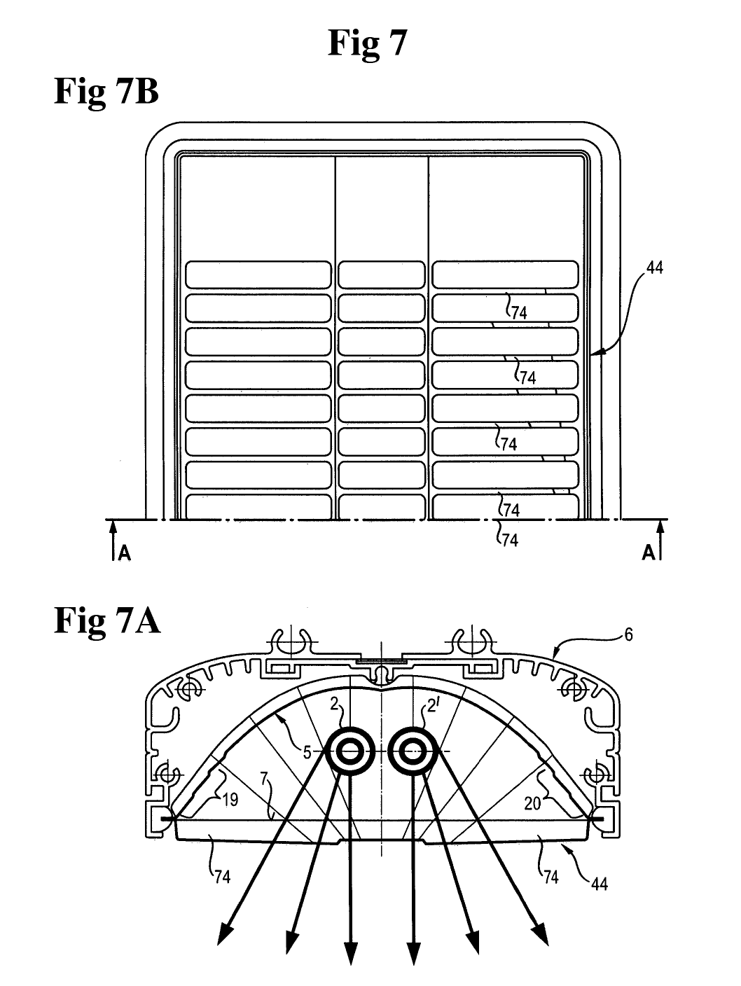

FIG. 7 shows in FIG. 7A a schematic cross-section through the radiant heater according to FIG. 6 along a section line A-A shown in FIG. 7B. This section plane is put precisely through a shielding lamella 74 so that, in FIG. 7A, the contour of such shielding lamella 74 of the grille structure 44 is shown in cross section. Radiant heaters up to 3200 watts can be realized with such a front grille structure 44 without the infrared reflector changing in its geometry throughout its total service life of more than 10000 hours of operation. This is supported by the above aforementioned crimps 24 and 24 in the lower boundary areas 19 and 20 of the infrared reflector 5.

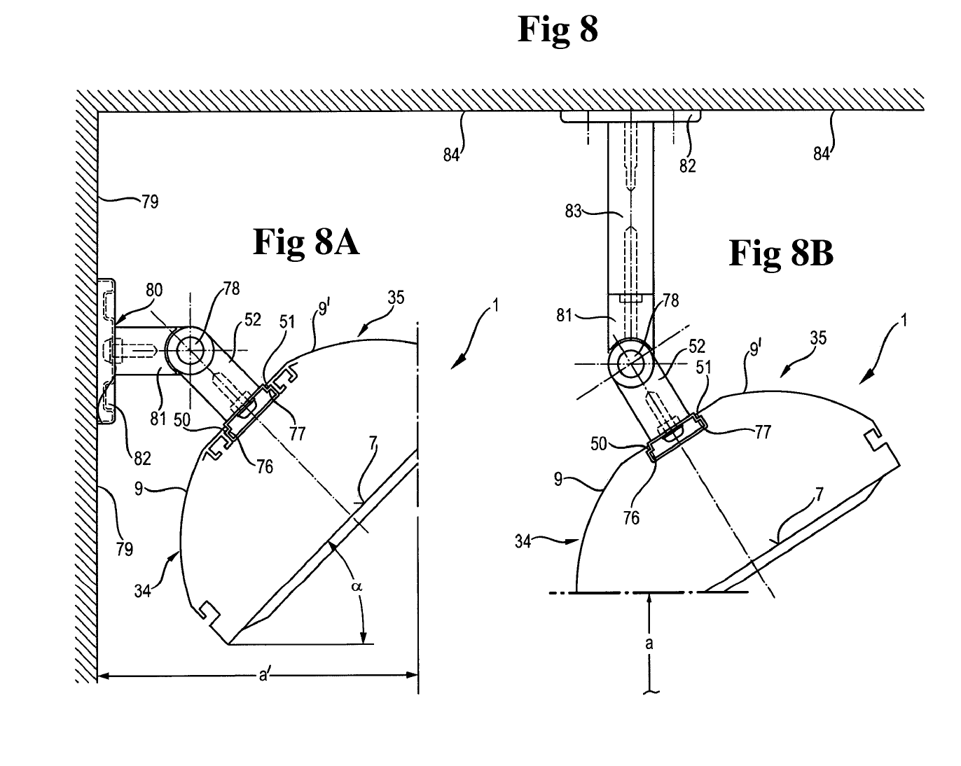

FIG. 8 shows with the FIGS. 8A and 8B schematic views of a radiant heater 1 in wall mounting and ceiling mounting. Guide rails 50 and 51 are therefore arranged in the housing rear side structures 9 and 9′ of the semi-shells 34 and 35, in which brackets 76 and 77 of a support arm 52 can slide displaceable, to be able to adjust the support arm 52 in an optimum position along the guide rails 50 and 51.

The support arm 52 is adjustably fixed by a hinge 78 to a wall stand 80 fixable to a wall 79, wherein the wall stand 80 is composed of a support rod 81 and a stand base 82, so that any adjustment angle α of the front side 7 of the radiant heater 1 is adjustable. For ceiling mounting, as shown in FIG. 8B, the same support arm 52 with the hinge 78 and the support rod 81 can be used, wherein the stand base 82 can now be fixed at a ceiling 84 and extension rods 83 can be disposed between the stand base 82 and the support rod 81 for setting an optimum radiation distance a from the area to be warmed.

Such extension rods 83 can also be used to vary a distance a′ of the wall 79 in FIG. 8A. It is thus possible to achieve the desired position of the front side 7 of the radiant heater 1 by using extension rods 83 with simple standardized components as a stand base 82, a support rod 81, a pivot hinge 78, and a support arm 52.

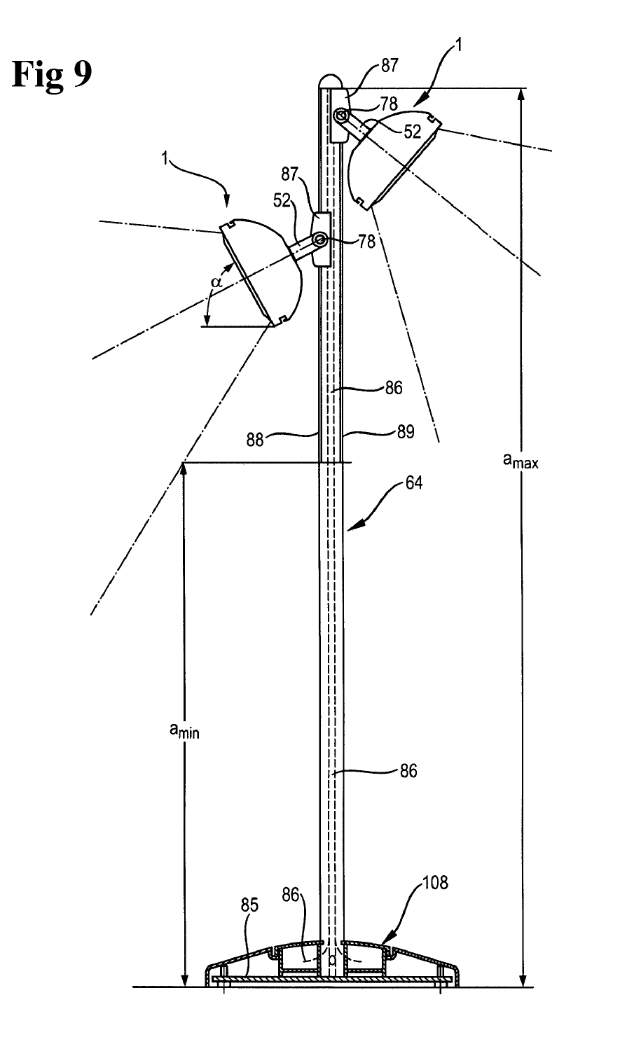

FIG. 9 shows a schematic view of radiant heaters 1, which are arranged vertically displaceable and pivotably on a post 64. The post 64 has a stand base 108, which is adapted to the external dimensions of the radiant heater 1, slidably and pivotally mounted on the stand 64. The stand 64 also has a stand base plate 85, constituting a stabilizing counterweight to the weight of the heater 1. The post 64 is essentially a tube profile in which the supply cables 86 of the stand base 108 to the heaters 1 are arranged.

In a lower portion of the post 64, for example, at a height aₘᵢₙ from the stand base 108 to a lower boundary, two guide rails 88 and 89 for the two radiant heater can be provided. Heater supports 87 comprising hinges 78, at which a respective support arm 52, as already shown in FIG. 8, is arranged for the radiant heater 1. The guide rails 88 and 89 extend to a maximum distance aₘₐₓ of, e.g., aₘₐₓ≦3.0 m, while the minimum distance aₘᵢₙ≦3.0 between the stand base 108 and the radiant heaters 1, for example, comprise a minimum distance aₘᵢₙ≧1.8. This provides that small children do not come close to the radiant heater 1 of the stand 64.

Such an arrangement of radiant heaters 1 on a stand 64 with a suitable stable stand base 108 has the advantage, that by stable mounting, the radiant heater 1 can be adjusted within a large range, e.g., between 1.80 m and 2.50 m, in their distance from the stand base 108. The tilt angle can also be adjusted via hinge 78. The radiant heater 1 can also be operated both in horizontal as well as in vertical orientation since the safety height of small children is maintained in any case and the vertical adjustability is limited between a minimum distance aₘᵢₙ and a maximum distance aₘₐₓ.

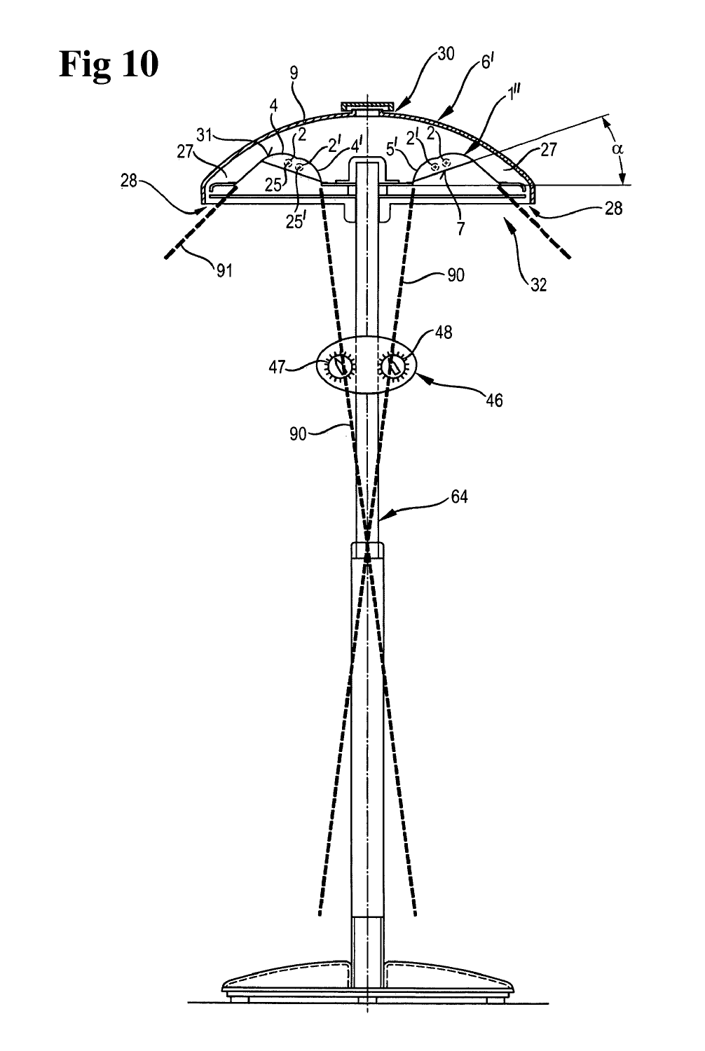

FIG. 10 shows a schematic view of a patio heater 32 which is placed on a post 64 which can arrange the patio heater 32 telescope like at different heights. On the post 64, a control unit 46 having a power level switch 47 and a temperature controller/server 48 may be arranged. The patio heater 32 differs from the previous heater in the ring-shaped heating tube elements 2 and 2′, arranged in focus areas 25 and 25′ comprising curvatures of an infrared radiant reflector 5′. In this case, the ring-shaped infrared reflector 5 is also ring-shaped, according to the heating tube elements 2 and 2′.

A front side 7 of the ring-shaped radiant heater 1″ has an inclination angle α, which allows the patio heater 32 to irradiate an enlarged radius in the environment with infrared radiation. The boundaries of the irradiation, caused by the rings-shaped infrared reflector 5′, are marked with dashed lines 90 and 91. By changing the angles α these boundaries can be moved.

The housing 6′ of the radiant heater 1″ is constructed as an umbrella shape. Between the umbrella-shaped rear side structure 9 and the rear side 31 of the ring-shaped infrared reflector 5′, an air convection channel 27 can be formed, wherein air is flowing through a ring-shaped opening 28 into the air convection channel 27 and flows out through a respective ring-shaped central opening 30 at the peak of the patio heater 32.

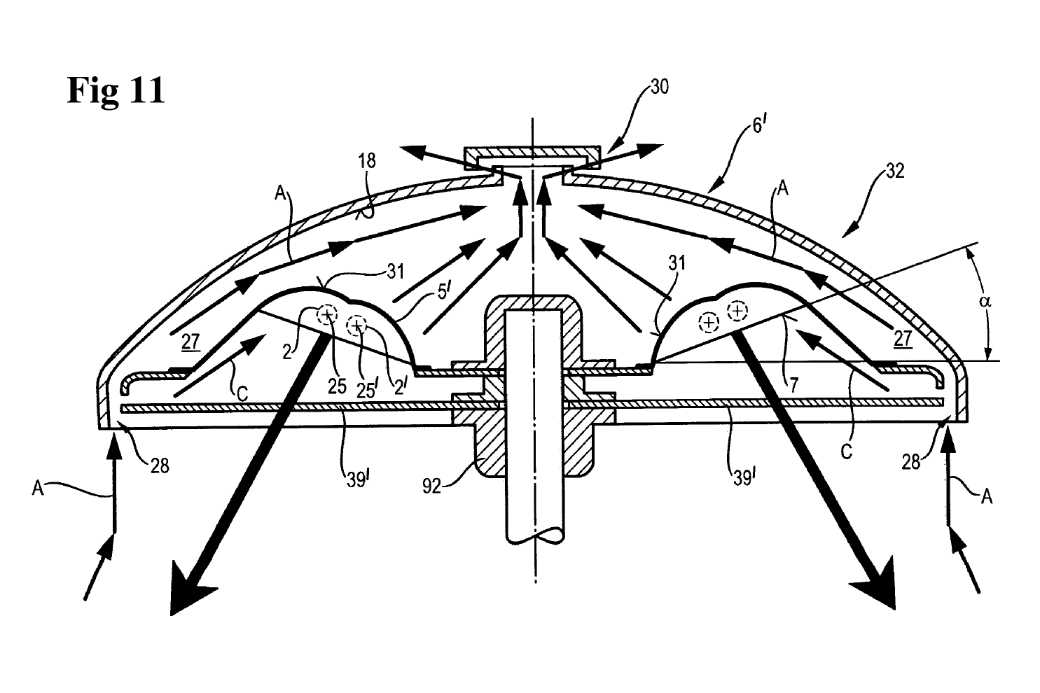

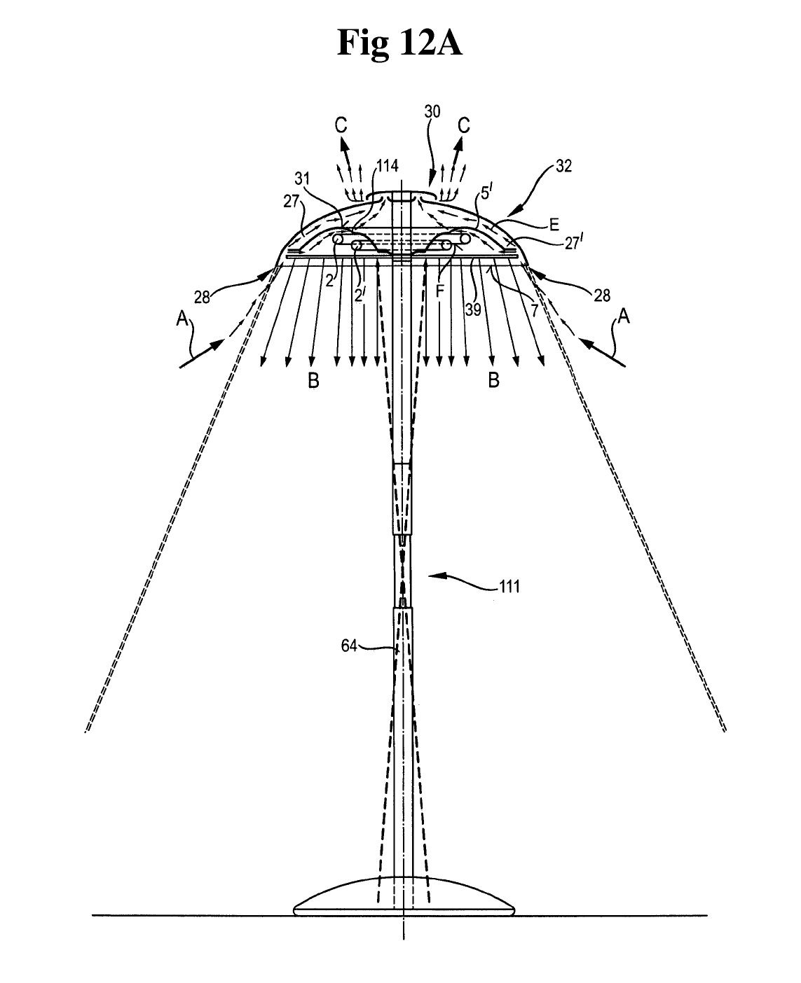

This will become clearer in FIG. 11, wherein FIG. 11 shows a schematic cross-section through the patio heater 32 according to FIG. 10 in detail. The convection in the air convection channel 27 is not limited merely to the distance between the outer surface 31 of the ring-shaped infrared reflector 5′ and an inner surface 18 of the umbrella-shaped housing 6, but also results an air convection between the infrared reflector 5′ and the ring-shaped front glass plate 39′, as arrow directions C show. Both the ring-shaped infrared reflector 5′ as well as the ring-shaped front glass plate 39′ are supported, maintained and fixed by a central supporting element 92, which extends into the patio heater 32.

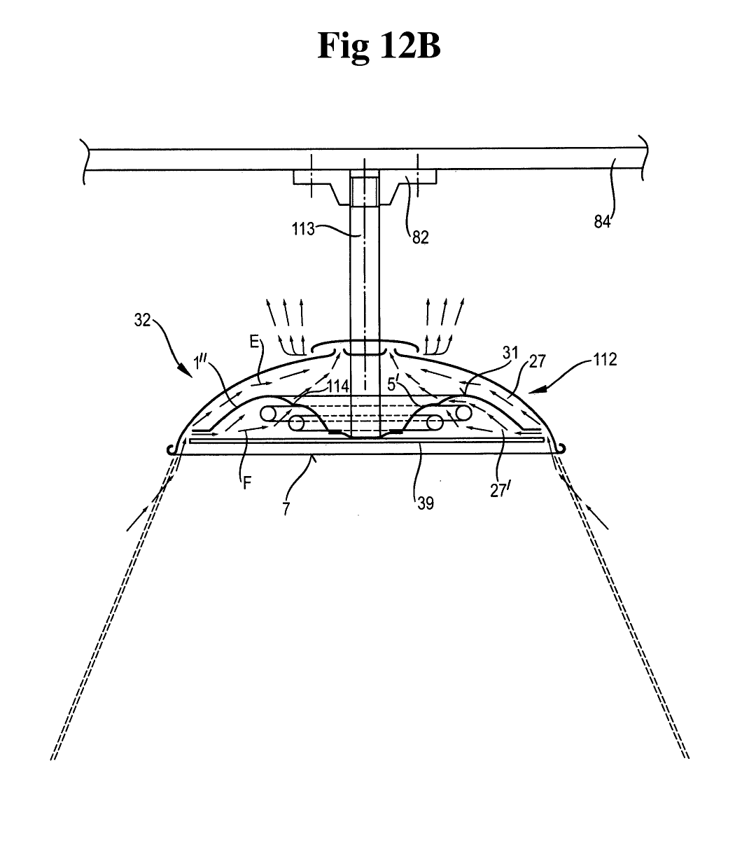

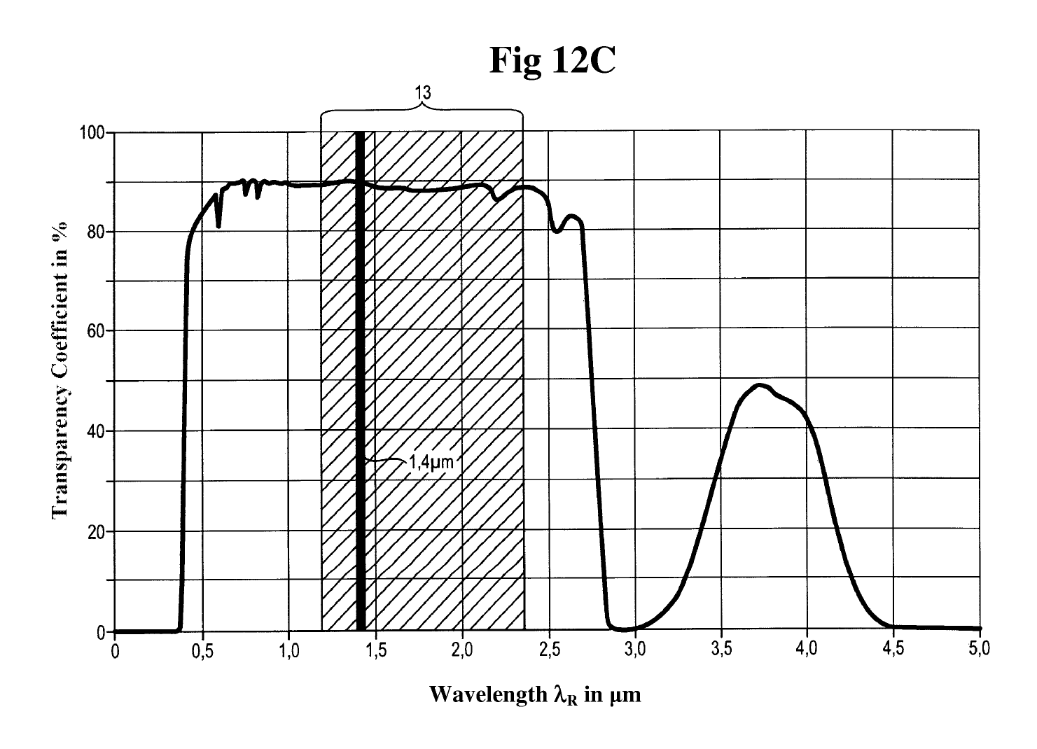

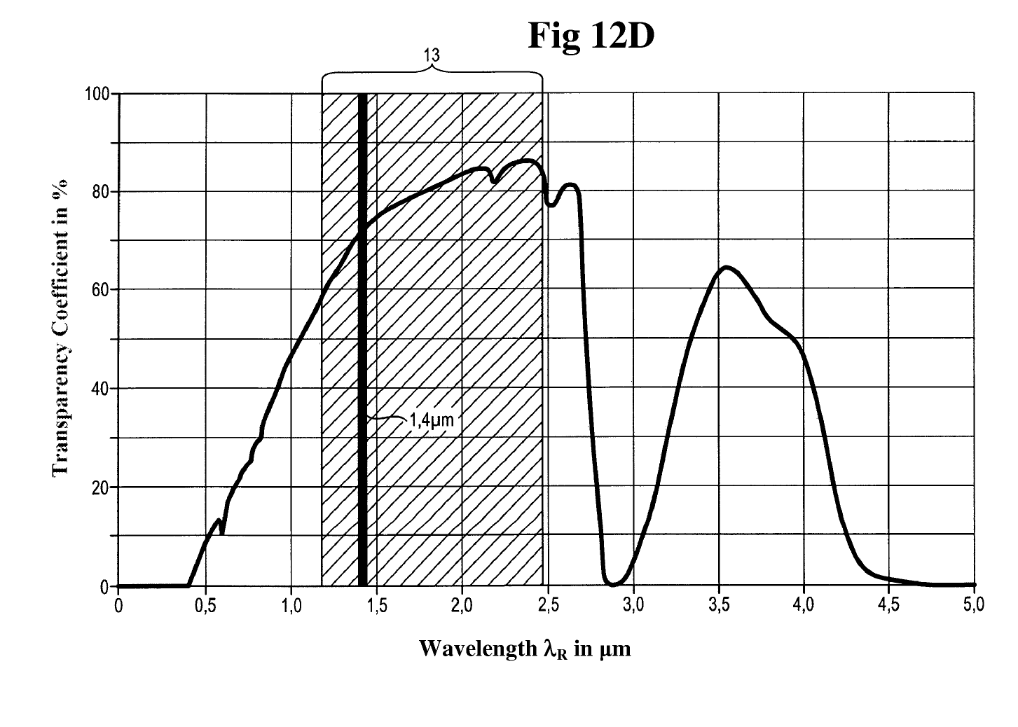

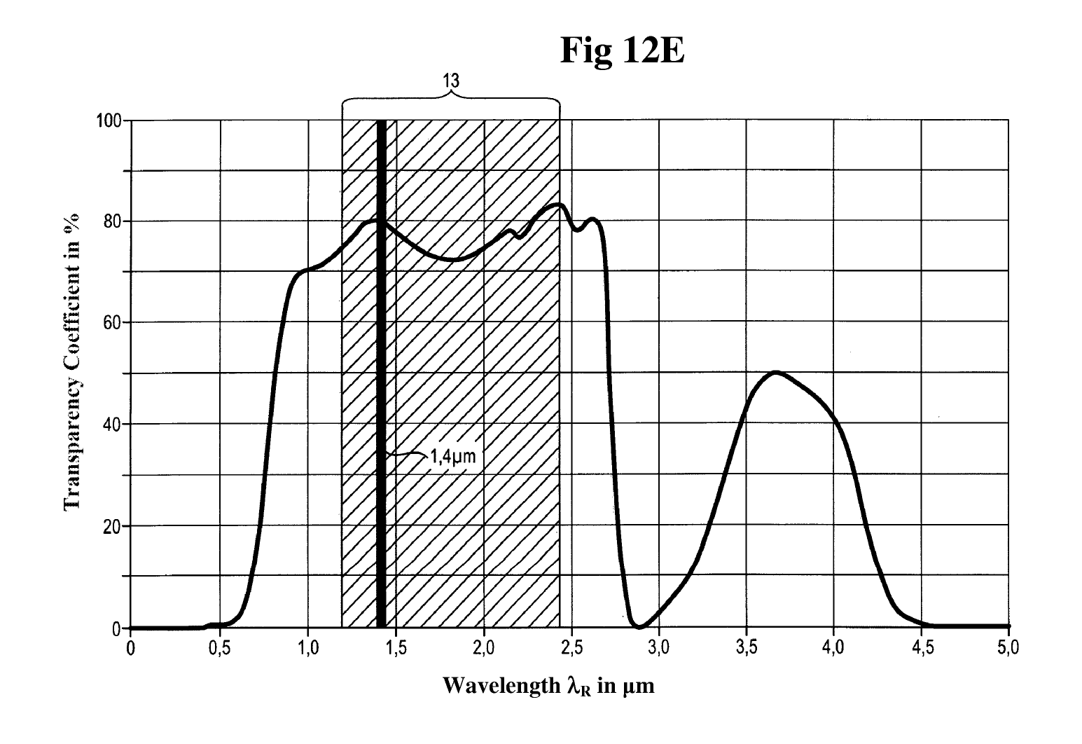

FIG. 12 shows with FIGS. 12A and 12B a radiant heater according FIG. 11 as a stand radiant heater and a ceiling radiant heater, and FIGS. 12C, 12D and 12E show transparency curves for different glass qualities of the front glass plate 39. For this purpose, a special glass plate is used as ring-shaped front glass plate 39, laminating colored during operation of the patio heater in arrow direction B, which on the one hand is colored with color pigments, which make the visible spectrum of the carbon heating coils appear at a filament temperature of, for example, 1800° C., and on the other hand, in the infrared frequency range of the ring-shaped 2 and 2′ of the heating tube elements 2 and 2′ remains infrared-non-transparent, as shown by the transparency curves in FIGS. 12C, 12D and 12E. The overall transparency of the colored shining front 7 of the heating- and patio heater 32 can thereby be reduced to less than 90%, as the subsequent diagrams of FIGS. 12C, 12D and 12E show.

FIG. 12C shows the course of the transparency coefficient for a first front glass plate quality for clear-eyed front glass plates with nearly 90% in both the visible light range and the inventive infrared transition area 13, including the absorption line for moisture or water molecules of 1.4 micrometres. After the transition area 13 according to the present invention, the infrared transparency falls off steeply.

The transparency in the visible light range is significantly reduced for white or milky appearing front glass plates of a second quality, as FIG. 12D shows, while in the inventive transition region 13, the transparency partially exceeds 80% and, after the transition area 13, again drops off steeply.

Even for a third quality of front glass plates appearing dark brown, the transparency in the visible light range is reduced and reaches in the inventive transition area partly 80%, as shown in FIG. 12E.

The construction of a floor lamp 111 having patio heater 32 of FIG. 12A corresponds to the construction according to FIG. 10. In the patio heater 32, two flows of air convection can propagate for cooling the infrared reflector 5′, with the ambient air flows via the annular slit 28 in the arrow direction A, and divides into two directions E and F, wherein the air in the arrow direction E is guided through the air convection channel 27 between the rear side 31 of the infrared reflector 5′. The air in the arrow direction F cools both the coloured or white front glass plate 39 as well as the inner surface of the infrared reflector 5′ and can pass via a pinhole 114 or a ring slit in the infrared reflector 5′ from the air convection channel 27′ to the air convection channel 27. Finally, through the common central opening 30, the heated cooling air escapes in the direction of arrow C into the environment.

FIG. 12B shows the same patio heater 32 now as a ceiling light 112 and at the same time as the radiant heater 1″, which immerse a room into a warm light atmosphere with simultaneous heat generation. For this purpose, only the post 64, which is shown in FIG. 12A, is replaced by a ceiling mounting rod 113 and fixed at a ceiling 84 with the stand base 82 shown in FIG. 8.

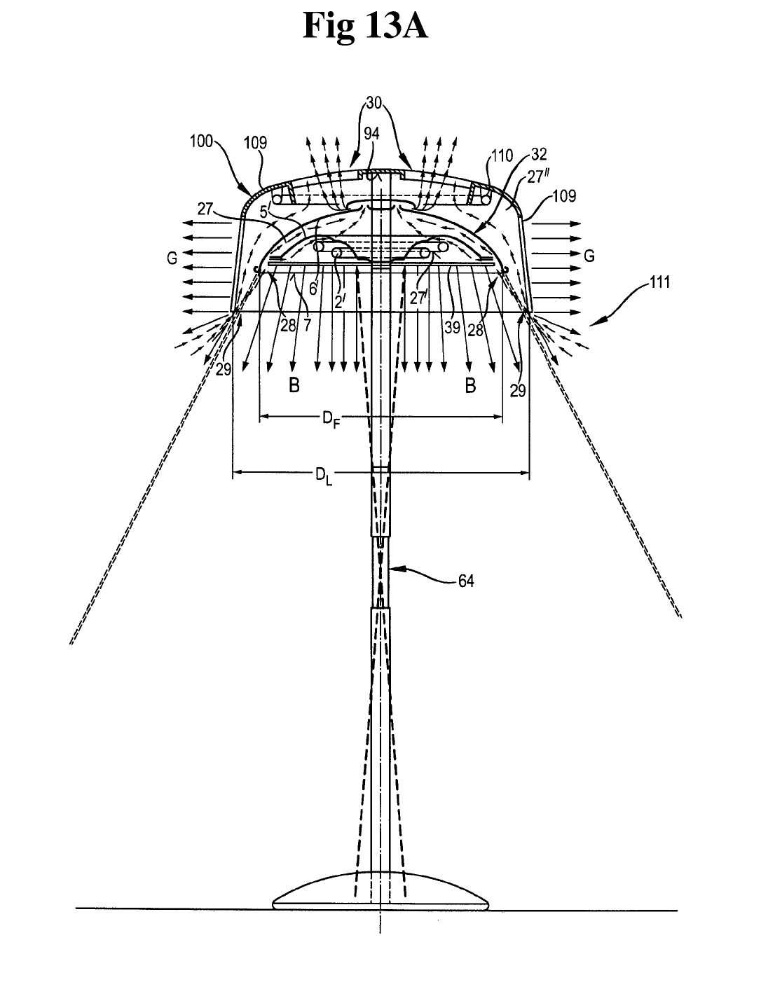

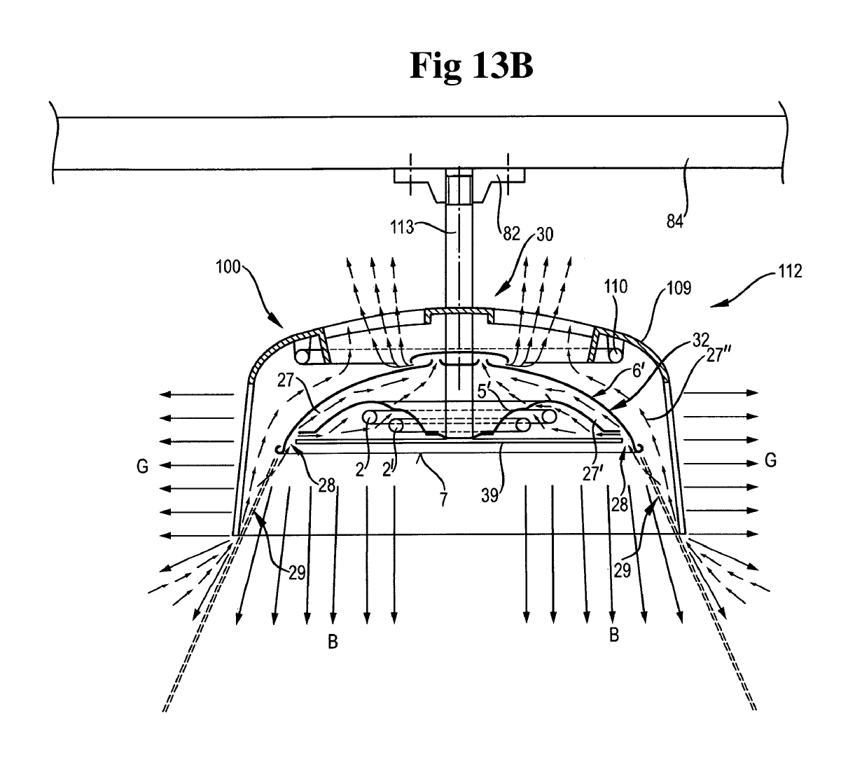

FIG. 13 shows with the FIGS. 13A and 13B a patio heater 32 having an enveloping structure 100 in the form of a lampshade 109. For this purpose, a decorative lampshade 109 is imposed over the patio heater 32, which in arrow direction G lights when light source/fluorescent tube 110 or an LED light ring or any other illumination means is operated in the visible light spectrum. The brightness of the standardized circular fluorescent tube 110 and the illumination means can respectively be continuously dimmed, regardless of power of the patio heater 32.

The diameter D_{L} of the lampshade 109 is slightly larger than the diameter D_{F} of ring-shaped front side 7 of the patio heater 32 so that the enveloping structure 100 in form of the lampshade 109 can be imposed over the patio heater 32 before the patio heater 32 is placed on the top 94 of the stand 64. The patio heater 32 itself may be additionally provided with a color appearing ring-shaped front glass 39 and, regardless of the light source/fluorescent tube 110, or the LED light ring, or the other lighting means, can emit colored light under the patio heater 32 in the arrow direction B.

Ambient air for cooling of the lampshade 109 and the infrared reflector can be supplied via coaxially disposed ring-shaped annular opening 28 and 29 and can be distributed to three air convection channels 27, 27′ and 27″. The air convection channels 27 and 27′ are similar to those in FIG. 12 and communicate with the opening 28. The air convection channel 27″ is disposed between the housing 6′ of the patio heater 32 and the lampshade 109 and communicates with the opening 29. The warmed cooling air from the three air convection channels 27, 27′ and 27″ finally exhausts through the central opening 30 arranged centrally in the lampshade 109.

FIG. 13B shows the same patio heater 32, now as ceiling light 112 with a lampshade 109 as enveloping structure 100 of the patio heater 32.

The room can be immersed in a warm light atmosphere synchronously to heat generation, and in addition, for example, a fluorescent tube or LED light ring 110 is disposed as illumination means under the lampshade. For ceiling mounting, only the post 64 shown in FIG. 13A is replaced by the ceiling mounting rod 113 fixed by means of the stand base 82 shown in FIG. 8 at a ceiling 84. The function of the lampshade 109 is not affected by the fixation at a ceiling 84.

As already indicated, the enveloping structure 100 can be of different shape, e.g., a trapezoidal shape, as in this embodiment as a lampshade 109, or a funnel shape, or a cylindrical shape or else a slim outer contour, e.g., being similar to a flower blossom. The power control and the temperature control of the infrared heater may be located remote from the enveloping structure 100 in a portable control unit, which is in operatively connected with a control module within the patio heater 32 is, wherein additionally a brightness control for the fluorescent tube 110 or for an LED light ring or any other illumination means may be integrated in the portable control unit.

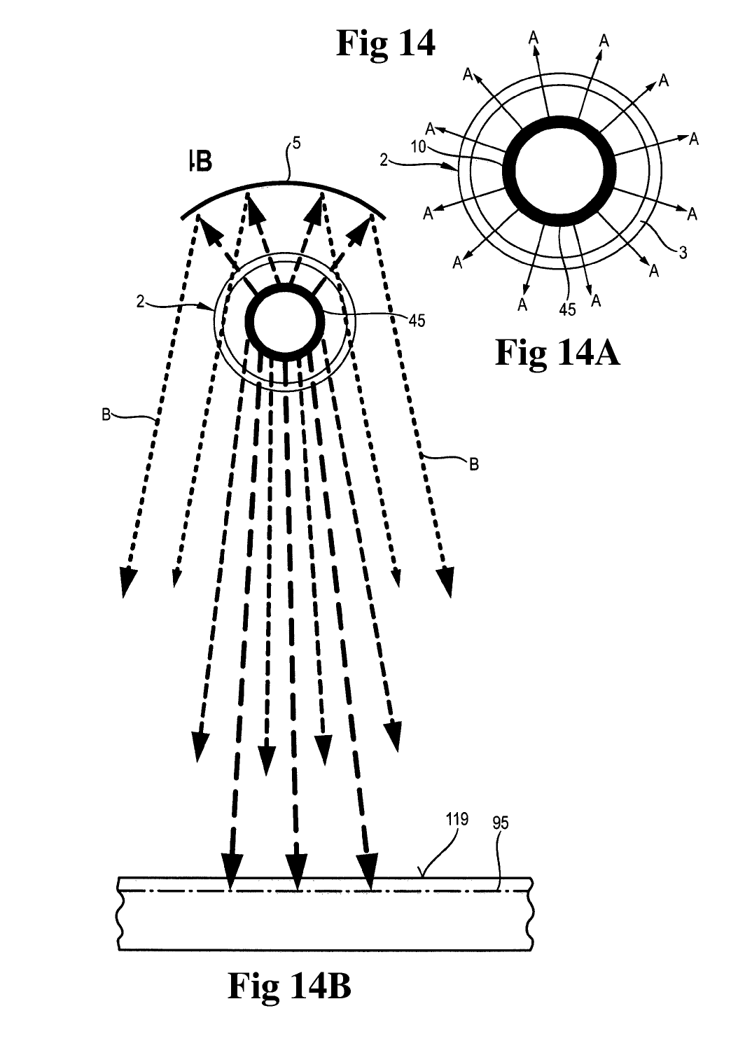

FIG. 14 shows with FIGS. 14A and 14B schematic cross-sections through an infrared heating tube element 2. The infrared heating tube element 2 radiates by means of a carbon heating coil 45 with a generally constant light intensity in all directions, as indicated by the radiation arrows A. The carbon heating coil 45 is made of braided carbon fibres 10, braided into a carbon string and wound up and dimensionally stabilized by a special process to form a dimensionally stable carbon heating coil 45.

The carbon heating coil 45, as shown in FIG. 14A, is exposed to a current in a heating tube 3 made of quartz glass, which is evacuated or filled with an inert gas, as already explained with reference to FIG. 2, and operated in the inventive temperature range between 1400° C. and 1800° C., wherein a radiation intensity maxima occurs in an inventive transition area of infrared wavelengths between 1.2 μm≦λ_{R}≦2.4 μm.

To use the entire radiation and directing them, for example, in one direction, an infrared reflector 5, as shown in FIG. 14B, is used, which provides that, due to a high, up to 98%, reflection coefficient of the infrared reflector 5, nearly the entire infrared radiation energy is reflected in the radiation directions specified in FIG. 14B. The infrared radiation of the inventive transition area reach, as FIG. 14B shows, a small immersion depth at surfaces 119 of different materials, as the chain dotted line 95 shown in FIG. 14B. However at a usual humidity, water molecules absorb the infrared radiation of 1.4 μm, so that the infrared radiation of a carbon radiant heater heats up humidity and water molecules quickly in this wavelength range, which provides for a pleasantly perceived warmed environment.

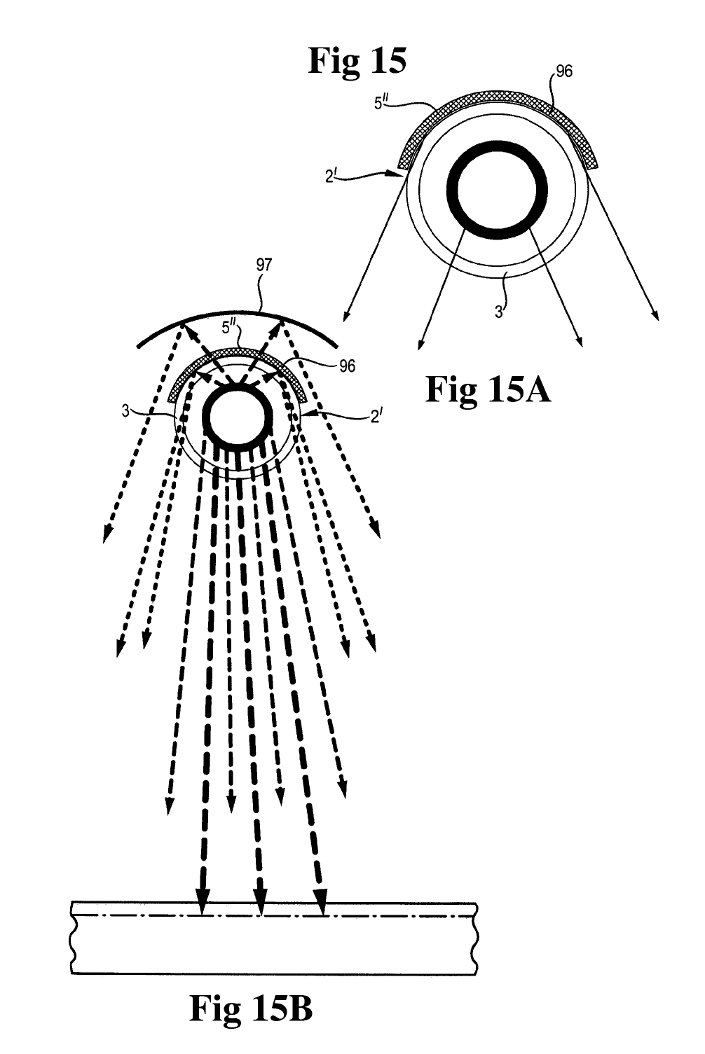

FIG. 15 shows with FIGS. 15A and 15B schematic cross-sections through an infrared heating tube element 2′, which differs from the heating tube element shown in FIG. 14 in that a reflector material is directly applied on the quartz tube 3, which is made of an oxide ceramics layer 96 and comprise a reflecting coefficient, which depends on the infrared wavelength, as shown in the diagram of FIG. 3, wherein the reflection coefficient is adapted to the inventive infrared wavelength range between 1.2 μm≦λ_{R}≦2.4 μm and up to 10 μm.

The directivity of this infrared reflector 5″ directly applied onto the heating tube 3 of the infrared heating tube element 2 is the same as the effect of the separate infrared reflector 5 shown in FIG. 14. However, this embodiment has the advantage that no additional supports, chamfers or other means for a floating positioning of the infrared reflector 5″ are required. This is particularly advantageous if the infrared heating tube 3 is to be inserted ring-shaped or u-shaped into a radiant heater. In addition, a heat shield 97, independent and spaced apart from the heating tube 3, can be positioned over or at the heating tube 3, to protect interior walls of radiant heaters.

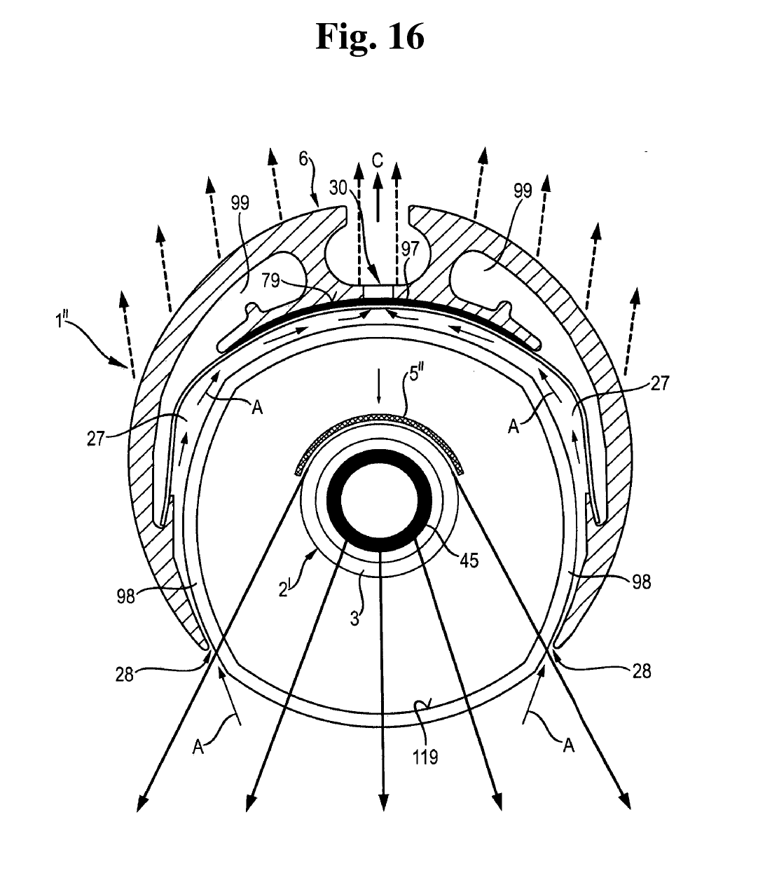

FIG. 16 shows a schematic cross-section through a compact radiant heater 1″ in accordance with another embodiment of the present invention. The housing 6 of the radiant heater 1″ is in its shape adapted to fit to a protection tube 98 and can be pushed onto the protection tube 98. The infrared heating tube element 2 here has the structure as shown in FIG. 15A.

The heat shield 97 shown in FIG. 15B is in FIG. 16B applied on an inner wall of the housing 6 which is adapted to protection tube 98. Forming an air convection channel 27 between the outer surface of the protective tube 98 and the inner wall 79 of the housing 6 with the heat shield 97, the heat occurring in this area can be dissipated in the air convection channel 27.

The protection tube 98 can, for example, be made of a quartz tube, the surface 119 of which is frosted, so that the infrared-transparent properties of the infrared radiation range are maintained and merely in the visible wavelength range diffusion of light radiation occurs. During operation of the glowing carbon heating coil 45, they do not become apparent on the protection tube 98 made of quartz glass with frosted surface 119.

The heat shield 97 between the protective tube 98 made of quartz glass and the aluminum housing profile with appropriate ventilation by the provided air convection channel 27 protects the material of the housing 6, which is arranged behind the heat shield 97, from overheating. A further channel 99 can thereby be provided behind the heat shield 97 to allow for internal electric wiring of the radiant heater 1″ and to protect the electrical wiring against overheating.

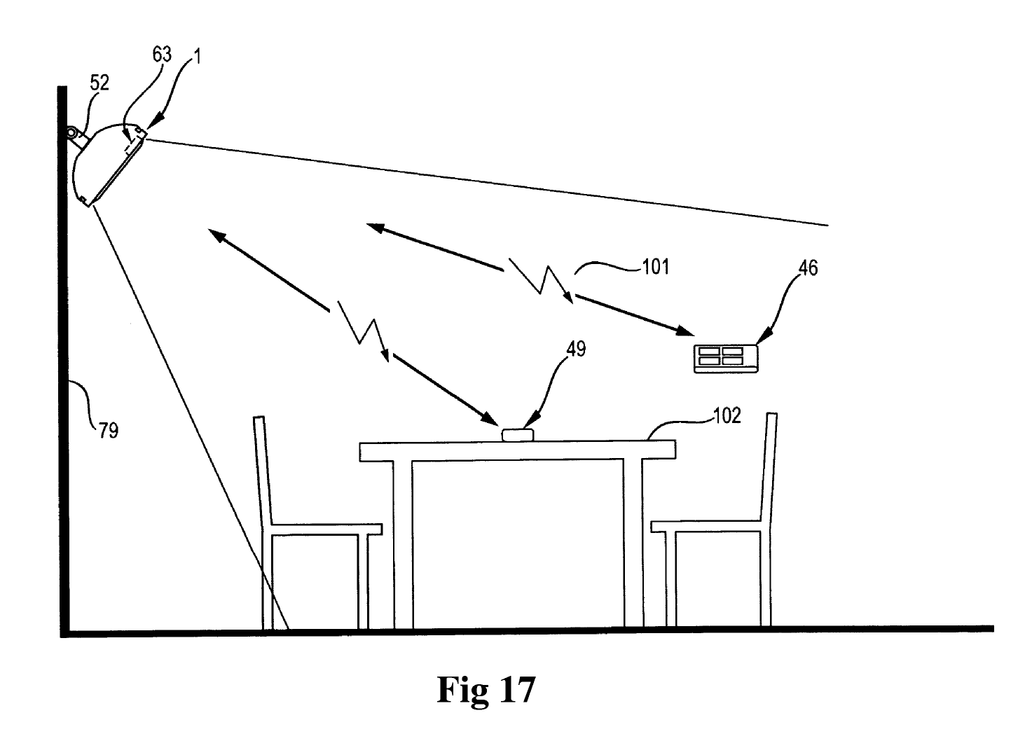

FIG. 17 shows a schematic sketch with remote-controlled power settings and temperature control of a radiant heater 1, which is fixed, for example, at an outer or an inner wall 79 with the support arm 52 shown in FIG. 9. In this embodiment of the present invention, radiant heater 1 is set both in power stage as well as temperature control by a portable control unit 46, which is here positioned, for example, on a table. For this purpose there is a radio link 101 between the portable control unit 46 and a control module 63 in the radiant heater 1. For temperature control, the portable control unit 46 which is arranged here on a table 102, comprises a temperature sensor unit 49, which detects the ambient temperature.

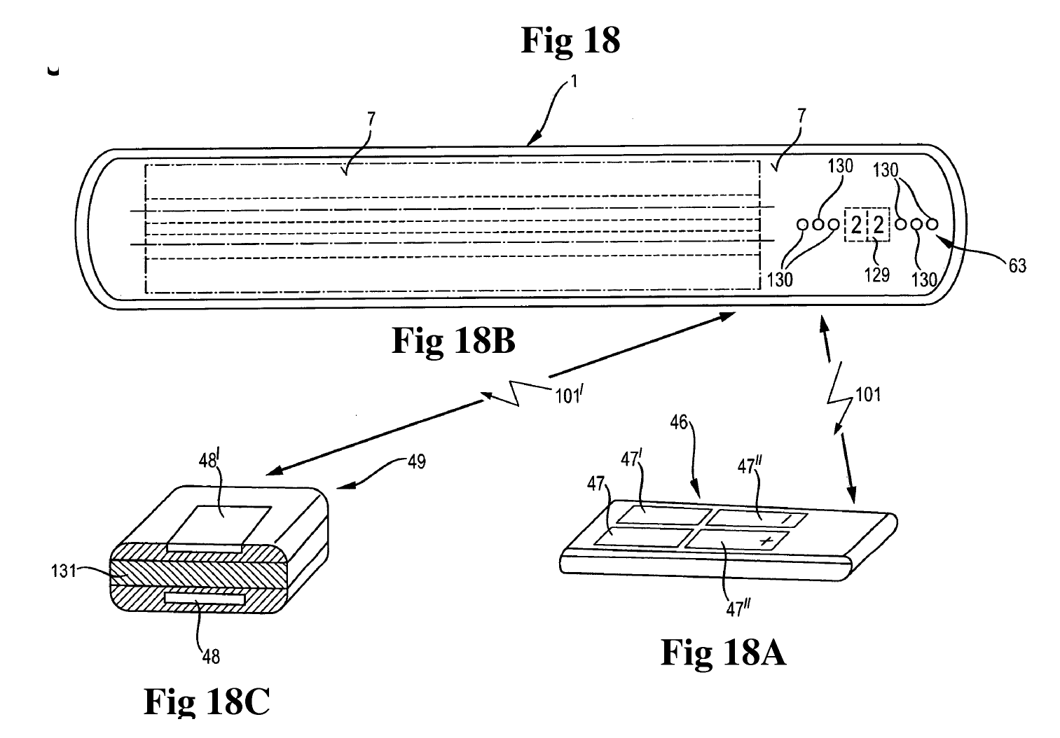

FIG. 18 shows to a schematic diagram of a switch unit in FIG. 18A of the portable control unit 46 for a radiant heater 1 with an on/off or timer switch 47, a power stage switch and program switch 47′, and + or − button 47″ for temperature or timer setting. This switch unit is connected via radio link 101 to a control module 63 on the front side 7 of the radiant heater 1, as shown in FIG. 18B.

In this embodiment of the present invention, the electrical and control module 63 comprise a display panel on the front side 7 of the radiant heater 1, centrally signaling the set temperature and comprising adjacent to the temperature display 129, for example, three LED-lights 130. The LED-lights 130 can signal an on-state of the radiant heater 1, a power control and on-state of a timer. In addition, three more LEDs 130 are provided for signaling of three power stages.

A temperature controller, which is integrated into the control module 63, is connected via radio link to a temperature sensor unit 49. The temperature sensor unit 49 has a room temperature sensor 48 within a housing and a radiation sensor 48′ on a surface of the housing, exposed to the radiation of the radiant heater 1. In the temperature sensor unit 49, which is partially shown in cross section in FIG. 18C, a radio electronic 131 is arranged which cooperates with the control module 63 via radio link 101′.

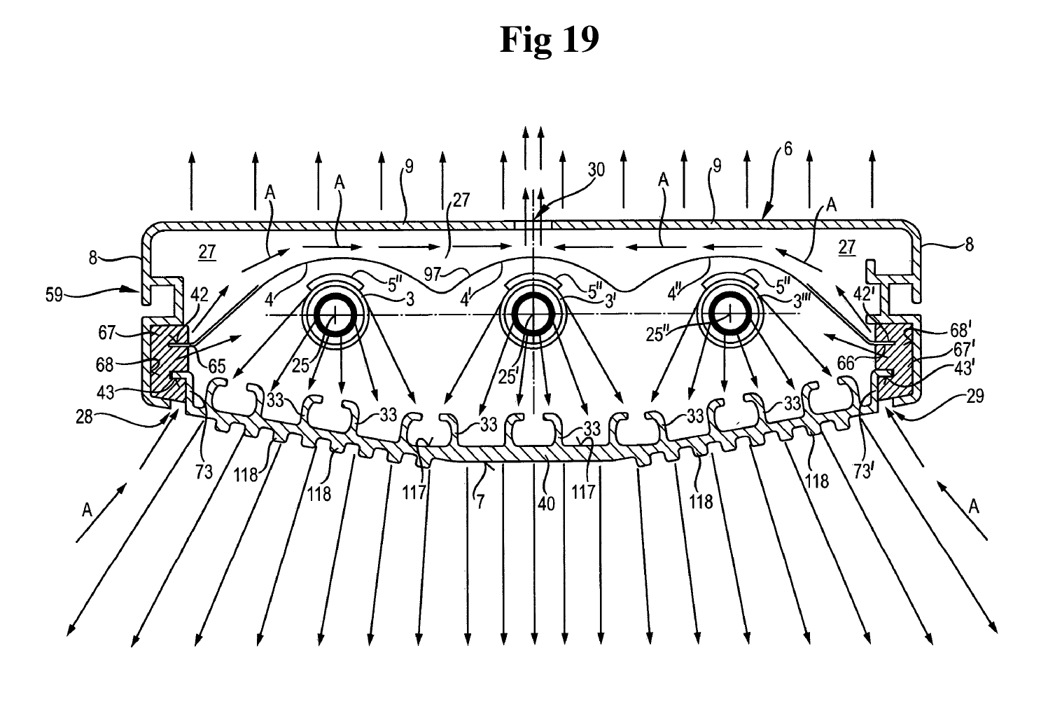

FIG. 19 shows a schematic cross-section through a further embodiment of the radiant heater as a dark radiator 59. The dark radiator 59 comprises in this embodiment of the present invention three juxtaposed elongated heating tubes 3, 3′ and 3″, each arranged in a focus area 25, 25′ and 25″ of curvatures 4, 4′ and 4″ of a common heat shield 97.

Between the heat shield 97 and an inner wall of the rear side structure 9 of the housing 6, an air convection channel 27 is arranged, which forms, in turn, by openings 28 and 29 in the form of long slits, an air convection flow in arrow direction A, wherein the air can escape through an upper central opening 30 of the rear side structure 9 of the housing 6, and thus heats the surrounding room air.

As the previous drawings show, six silicone profile pieces 67 and 67′ are arranged in guide grooves 68 and 68′ in the border side structures 8 and 8′ of the housing 6. The silicone profile pieces 67 and 67′ comprise two longitudinal slits 42 and 43 lying upon each other, wherein in the longitudinal slits 42 and 42′ chamfers 65 and 66 of the heat shield 97 are floatingly supported, while in the second elongate longitudinal slots 43 and 43′ of the silicone profile pieces 67 and 67′ angle pieces 73 and 73′ of a structured front cover 40 are arranged, covering the entire front side 7 of the dark radiator 59.

The front cover 40 is made of an extruded profile of aluminum alloy and has bulges 33 on the inner wall 117 of the front cover 40, which high effectively absorb the infrared radiation in the inventive infrared wavelength range between 1.2 μm≦λ_{R}≦2.4 μm and serve for a transformation into heat radiation so that the front cover 40 irradiates on a heat radiation in the long-wave infrared range IR-C between 250° C. and 500° C., for example, between 300° C. and 400° C.

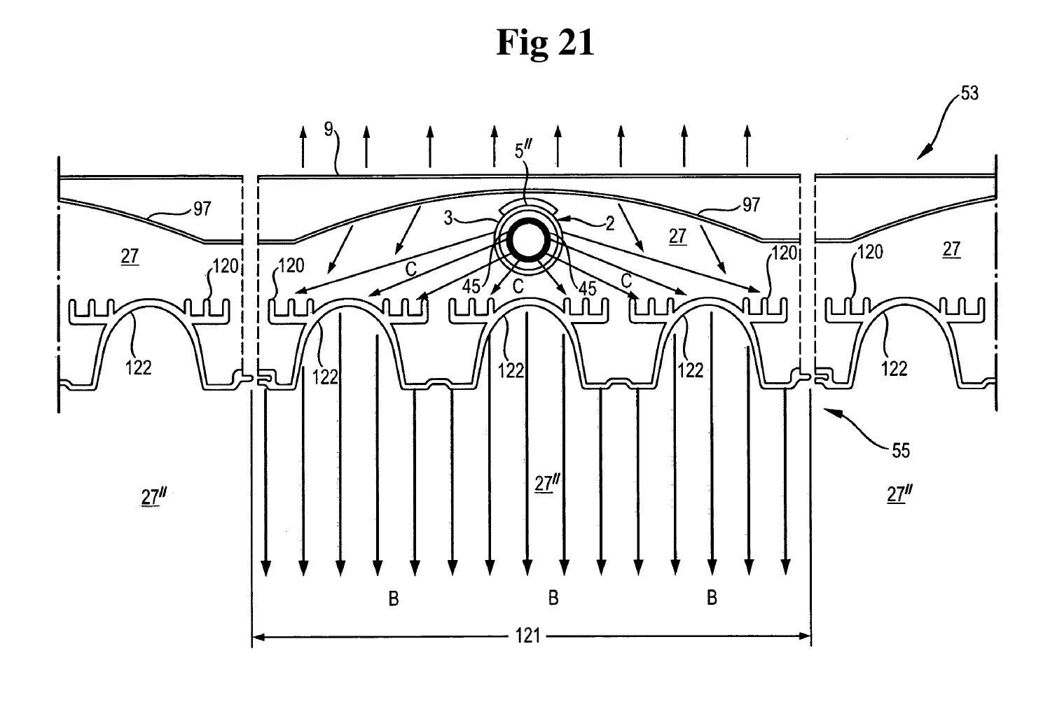

The outer contour of the front cover 40 has radiation ribs 118 equidistantly arranged, which provide an intensive contact with the surrounding air and the ambient humidity. The heating tube elements 3, 3′ and 3″ have in addition to the heat shield 97 infrared reflectors 5″ directly applied on the quartz tubes of a reflector coating of oxide ceramics. The novel heating profile having more effective heat absorption of long-wave infrared range and emitting to the surrounding air is further illustrated in FIG. 21.

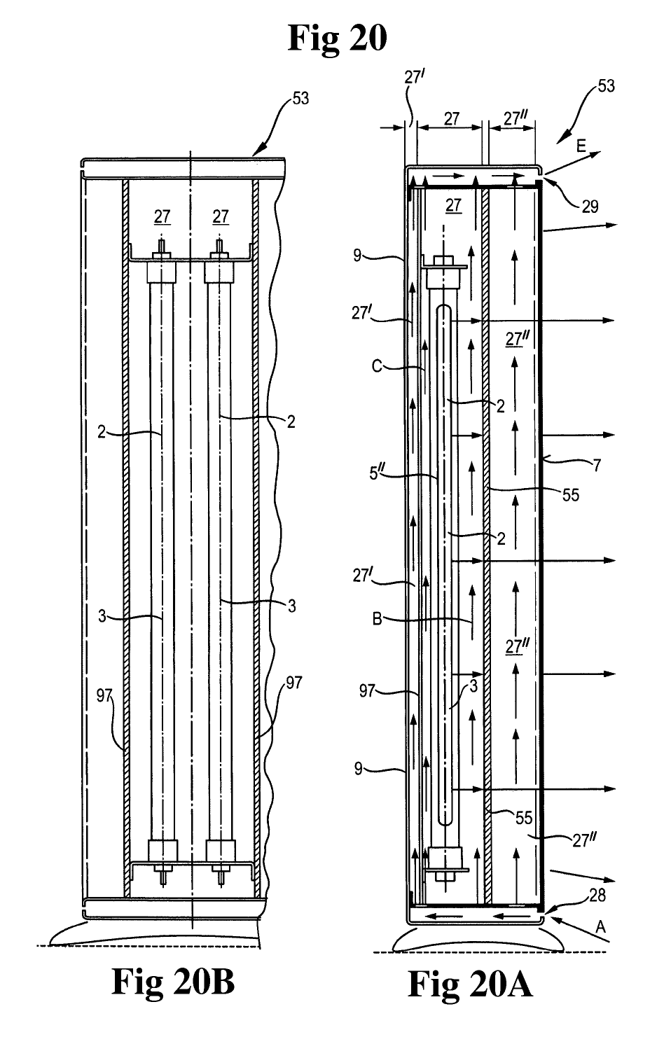

FIG. 20 shows with FIGS. 20A and 20B schematic cross sections through an infrared radiator 53 according to another embodiment of the present invention. In this embodiment, the infrared radiator 53 is a standalone unit which can be placed in a room to be heated, in particular if the air is to be heated as quickly and swiftly as possible.

For this purpose, the infrared radiator 53 comprises a housing 6 in which a plurality of air convention channels 27, 27′ and 27″ are provided. A first air convection channel 27 receives the cool and humid ambient air, flowing in arrow direction A, and directs it in arrow direction B and C directly close to the heating tube radiators 2 of quartz tube with internal carbon heating element 2, so that this air and in particular the moisture molecules are exposed to the inventive infrared radiation range, as repeatedly mentioned, including the water absorption line 1.4 μm, so that the humidity relatively quickly and efficiently produces hot water molecules, which mix with the ambient air and exhaust through corresponding openings 29 at the top end of the infrared radiator.

Infrared heating tube elements 2 having a quartz tube are thereby used in this radiator, which has on its rear side an infrared reflector 5″ of anodized aluminum directly applied, so that on the rear side of the infrared heating tubes 3, the radiated heat is strongly attenuated. However, a ventilation flow is passed in the air convection channel 27 in the arrow direction C and also absorbs heat, which is emitted via the air flow C through an upper opening 29 to the ambient air.

Finally, the rear side structure 9 of the housing 6 is cooled by a further cooling air flow, wherein in the air convection channel 27′ the air sweeps similar to a rear ventilation at the rear side 9 of the infrared radiator 53 between a heat shield 97 and contributes to the warming of the air exhausting out of the upper opening in arrow direction E.

A further air convection channel 27″, allowing the cooler air flowing into the air convection channel 27″ via the bottom opening 28′, said air convection channel 27″ is separated from the infrared heating element 3 by an intermediate wall 55. The structure of the intermediate wall 55 is shown in FIG. 21 in cross section. In the third air convection channel 27″, the heating of the ambient air is delayed, but is then heated with increased efficiency, as soon as the partition wall 55 has reached an operating temperature between 200° C. and 800° C., for example, between 350° C. and 600° C. By absorbing the energy in the air convection channel 27″, the front side 7 is merely heated up to the temperature ranges permissible for infrared radiators, which are far below the temperature of the partition wall 55.

By the construction of three separated parallel air convection channel 27, 27′ and 27″, with this infrared radiator 53, at first a rapid heating of the humid room air is achieved by the first air convection channel 27 and a permanent heating by the second air convection channel 27′ and in particular by the third air convection channel 27″, working in the long-wave infrared range IR-C, can be provided.

FIG. 20B therefore shows an excerpt of two parallel arranged heating tube elements 2 which have a corresponding reflector coating on their rear sides and are in addition spaced and partially enclosed by a common heat shield 97 in the form of an additional heat reflector.

FIG. 21 shows a schematic cross-section through an intermediate segment 121 of an intermediate wall 55 in the infrared radiator 53 according to FIG. 20. Such a structure of an intermediate wall 55 can also be used as a front cover 40 for the dark radiator 59 shown in FIG. 19. Heating tubes 3 with partially frosted surfaces are therefore used having an oxide ceramics reflector 5″ on the outside of the quartz tube of the heating tube element 2. In addition, behind the carbon heating tube elements 2, an anodized aluminum plate is used as a heat shield 97 to reflect the residual heat radiation yet acting in rear side direction. There is thus a double protection against a heating of the rear side structure 9 of the housing.

The intermediate wall 55 is stuck together from several intermediate wall segments 121. The intermediate wall segments 121 are extruded aluminum profiles. The aluminum profiles comprise a plurality of heat absorption ribs 120, facing the infrared heating tube element 2, which are distanced to each other and are oriented on one of the heating tube elements 2. The heat-absorbing ribs 120 are fixed to aluminum arches forming some kind of hollow radiator and releasing the radiation energy converted into long-wave infrared to the third air convection channel 27″ in arrow direction B. In the first air convection channel 27, which forms on the rear side of the intermediate wall 55 and arranged between the rear side of the intermediate wall 55 and a heat shield 97 of reflector material, the infrared radiation generated by the carbon coil 45 is emitted in arrow direction C and warm in particular humidity and water molecules in the first air convection channel 27, which is in intermediate connection to the carbon heating tube element 2.

Due to the special profiling of the heat absorption ribs 120 on the rear side of the intermediate wall 55 and by the curved infrared radiation profiles in the form of aluminum sheets 122 on the front side of the intermediate wall 55, a rapid heating a thin-walled intermediate wall can already take place through itself, and with little delay also the air convection channel 27″ between the intermediate wall 55 and the (not shown) front wall of the infrared radiator can serve for a quick permanent heating of the environment.

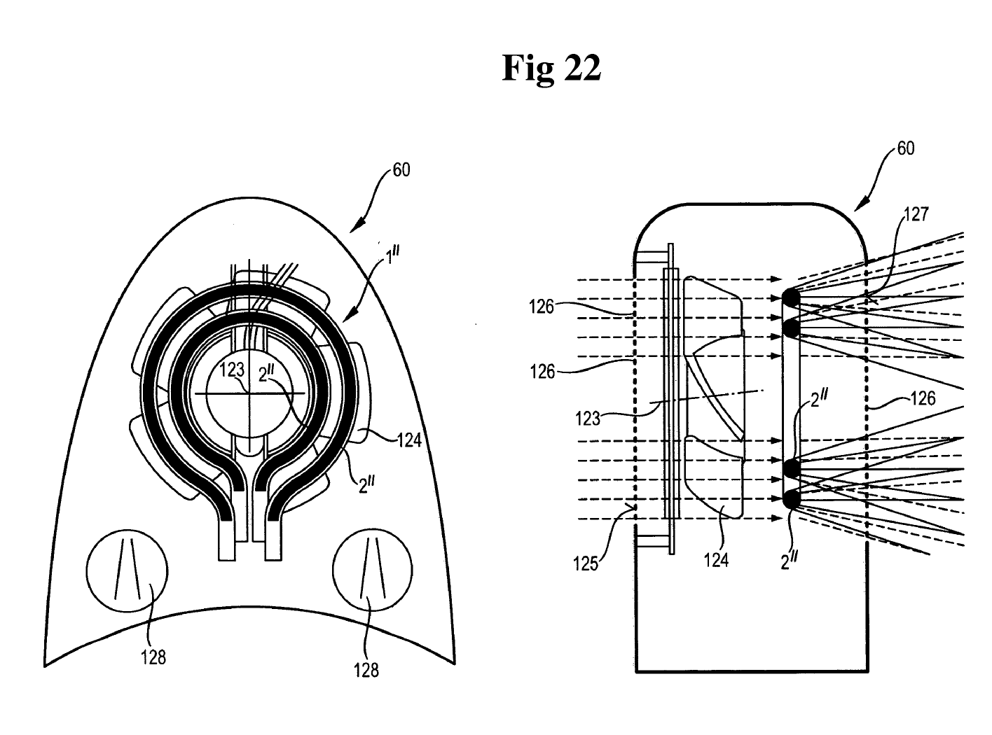

FIG. 22 shows with FIGS. 22A and 22B schematic views of a heater-fan 60 having an infrared heater 1″ made of ring-shaped infrared heating tube elements 2″, wherein in this embodiment of the present invention, two of the heating tube elements 2″ are arranged coaxially in each other, and as already described above, made from quartz tubes made having a reflector coating. The reflector coating is directly applied onto the heating quartz tube and is made essentially of aluminum oxide as an anodized coating. The ring of the heating tube element 2″ is arranged so that it is positioned coaxially to the axis 123 of an axial fan 124 and the fan air, as shown in the FIG. 22B, to pass directly the infrared carbon heating elements 2″.

The passing air, enriched with humidity, is thereby quickly heated due to the absorbance capacity at the infrared wavelength of 1.4 μm for moisture in the air and produces a pleasant room climate, whereby the heater fan 60 is protected by respective jalousies 126 both in the inlet area 125 as well as in an outlet area 127, so that the radial fan 60 may operate without interference. Directly located at the heater fan 60 corresponding switching elements 128 can be arranged, on the one hand to gradually turn the power, on the other hand to adjust and regulate the temperature by degrees or continuously via a room thermostat with a temperature controller.

Instead of an axial fan, in a further embodiment of the present invention (not shown), a radial fan may be provided, which cooperates with at least one elongate carbon heating coil in at least one straight heating tube element. A grille of heating tube elements can, for example, cooperate with such a radial fan.

Although at least one exemplary embodiment has been shown in the foregoing description, various amendments and modifications may be made. The embodiments mentioned are merely examples and are not intended to limit the scope, applicability, or configuration of the radiant heater with heating tube element in any way. Rather, the preceding description provides to those skilled in the art plan for implementation of at least one exemplary embodiment, wherein numerous amendments within in the function and the arrangement of the radiant heater with heating tube element of elements described in exemplary embodiments can be made, without leaving the scope of the appended claims and their legal equivalents. Reference should also be had to the appended claims.

### LIST OF REFERENCE NUMERALS

1, 1′, 1″ radiant heater

2, 2′, 2″ radiant tube element/infrared heating tube element

3, 3′, 3″ heating tube out of from quartz

4, 4′, 4″ curvature

5, 5′, 5″ infrared reflector

6 housing

7 front side

8, 8′ border side structure

9, 9′ rear side structure

10 carbon fiber

11 infrared heating coil

12 carbon string

13 transition area

14 end area

15 metal transition element out of from Nickel

16 molybdenum band

17 via contact

18 inner surface

19 boundary area

20 boundary area

21, 21′ segment strip

22, 22′ segment strip

23, 23′ segment strip

24, 24′ crimp

25, 25′, 25″ focus area

26 protection tube

27, 27′,27″ air convection channel

28 opening

29 opening

30 central opening

31 rear side

32 patio heater

33 bulge

34 semi shell

35 semi shell

36 connecting member

37 housing rear side

38 perforated metal strip

39, 39′ front glass plate

40 front cover

41 protective plate

42 longitudinal slit

43 longitudinal slit

44 front grill structure

45 carbon heating coil

46 control unit

47 power level switch

48, 48′ temperature sensor (room- or radiation-)

49 temperature sensor unit

50 guide rail

51 guide rail

52 support arm

53 infrared radiator

54 infrared radiator housing

55 intermediate wall

56 inner wall

57 radiating heater

58 fan

59 dark radiator

60 heater fan

61 external connector

62 connecting wire/string

63 control module

64 post

65 chamfer

66 chamfer

67 silicone profile piece

68 guide groove

69 bulge

70 guide rail

71 guiding channel

72 attachment region

73, 73′ bracket/angle piece

74, 74′ lamella

75 transverse rib

76 bracket

77 bracket

78 hinge

79 wall

80 wall stand

81 support rod

82 stand base

83 extension rods

84 ceiling

85 stand base plate

86 supply cable

87 heater supports

88 guide rail

89 guide rail

90 dashed line

91 dashed line

92 supporting element

93 telescopic transition

94 top

95 chain dotted line

96 oxide ceramic

97 heat shield

98 protection tube

99 channel

100 enveloping structure

101, 101′ radio link

102 table

103 bulge

104 extension

105 external assembly nuts

106 edge (of front glass plate)

107 ornamental and clamping frame

108 stand base

109 lampshade

110 light source (fluorescent tube, LED light ring)

111 floor lamp

112 ceiling light

113 ceiling mounting rod

114 pinhole

115, 115′ shielding rib

116, 116 board

117 inner wall

118 radiation rib

119 surface

120 heat-absorbing rib

121 intermediate segment

122 aluminum sheet

123 axis

124 axial fan

125 inlet area

126 jalousie

127 outlet area

128 switching element

129 temperature display

130 LED light

131 radio electronics

λ_{R} infrared wavelength

R reflection coefficient

T_{B} operating temperature

Tᵣ transparency coefficient

What is claimed is:

1-28. (canceled)

29. A radiant heater comprising:
at least one heating tube element comprising,
a heating tube which is transparent or semi-transparent to infrared radiation, and
carbon fibers arranged within the heating tube, the carbon fibers being configured to form an infrared heating coil comprising a carbon string, the infrared heating coil being configured to be dimensionally stable;
at least one infrared reflector comprising a focusing curvature which comprises a focus area, the at least one infrared reflector being adapted to the infrared spectrum of the at least one heating tube element, the at least one heating tube element being arranged in the focus area of the curvature; and
a housing comprising a border side structure, a rear side structure, and at least one front face which is configured to be open, transparent or semi-transparent for infrared radiation, the border side structure and the rear side structure being arranged to surround the front face so as to shield from infrared radiation.

30. The radiant heater as recited in claim 19, wherein the carbon string of the infrared heating coil comprises a round cross-section.

31. The radiant heater as recited in claim 29, wherein the carbon string of the infrared heating coil comprises laid carbon fibers, interlaced carbon fibers, braided carbon fibers, knitted carbon fibers, or woven carbon fibers.

32. The radiant heater as recited in claim 29, wherein the infrared heating coil comprises, in an operating state, infrared radiation comprising an infrared wavelength having a maximum in a transition area of from 1.2 μm to 2.4 μm.

33. The radiant heater as recited in claim 32, wherein the maximum of the infrared wavelength is at about 1.4 μm.

34. The radiant heater as recited in claim 29, wherein the carbon fibers of the infrared heating coil have an operating temperature of from 1400° C. to 1800° C.

35. The radiant heater as recited in claim 29, wherein the carbon fibers of the infrared heating coil have an operating temperature of from 1580° C. to 1620° C.

36. The radiant heater as recited in claim 29, further comprising:
a molybdenum band; and
a via contact,
wherein,
the infrared heating coil further comprises an end area which is configured to be gas-tight, the end area comprising a metal transition element,
the end area is configured to merge into the molybdenum band, and
the molybdenum band is configured to be electrified by the via contacts through the end area of the heating tube.

37. The radiant heater as recited in claim 36, wherein the metal transition element is nickel.

38. The radiant heater as recited in claim 29, wherein the heating tube comprises a quartz glass comprising a transparency coefficient of at least 0.99 in a transition area of infrared radiation of from 1.2 μm to 2.4 μm.

39. The radiant heater as recited in claim 38, wherein the quartz glass of the heating tube is a quartz glass semi-transparent comprising a frosted internal surface or a particle-blasted opaque internal surface.

40. The radiant heater as recited in claim 29, wherein the at least one infrared reflector further comprises a curved surface which comprises a mirror coating of a metal oxide on a side facing towards the infrared heating coil, the minor coating comprising a reflection coefficient of from 0.85 to 0.98 for infrared radiation having an infrared wavelength of from 1.2 μm to 2.4 μm.

41. The radiant heater as recited in claim 40, wherein the metal oxide is Al₂O₃.

42. The radiant heater as recited in claim 40, wherein the reflection coefficient is from 0.92 to 0.98.

43. The radiant heater as recited in claim 29, further comprising:
a protective tube arranged to be partially surrounded by the housing; and
an air convection channel arranged between the protective tube and the housing.

44. The radiant heater as recited in claim 29, wherein,
the at least one infrared reflector further comprises a curved outer surface, and
the housing further comprises an inner surface which is spaced apart from the curved outer surface, and
further comprising,
an air convection channel arranged between the at least one infrared reflector and the housing, the air convection channel comprising openings to a surrounding air, the openings being configured to have different heights above sea level during an operating of the radiant heater so as to form a cooling air convection along the curved outer surface of the at least one infrared reflector and along the inner surface of the housing.

45. The radiant heater as recited in claim 29, further comprising:
a front glass plate configured to have a high temperature resistance and to appear white, colored or opaque black in a visible light spectrum,
wherein,
the housing further comprises at least one front side configured to be transparent or semi-transparent for infrared radiation, the front side comprising a front cover which is configured to be covered by the front glass plate.

46. The radiant heater as recited in claim 45, further comprising:
a protective plate arranged between the front glass plate and the heating tube element, the protective plate being transparent for infrared radiation,
wherein,
the at least one front side further comprises an air convection channel arranged between the front glass plate and the protective plate, the air convection channel comprising an air inlet opening and an air outlet opening which are formed as at least one longitudinal slit.
